(19) United States
(12) Patent Application Publication
(10) Pub. No.: US 2020/0026289 A1
(43) Pub. Date: Jan. 23, 2020

(54) DISTRIBUTED TRAFFIC SAFETY CONSENSUS

(71) Applicants: Ignacio J. Alvarez, Portland, OR (US); Rafael Misoczki, Hillsboro, OR (US); Andrea Miele, San Jose, CA (US)

(72) Inventors: Ignacio J. Alvarez, Portland, OR (US); Rafael Misoczki, Hillsboro, OR (US); Andrea Miele, San Jose, CA (US)

(21) Appl. No.: 16/586,968

(22) Filed: Sep. 28, 2019

(51) Int. Cl. G05D 1/00; G06N 5/04; G06N 20/00; G07C 5/08; G06F 16/27

(52) U.S. Cl. CPC G05D 1/0088; G06N 5/04; G06N 20/00; G05D 1/101; G06F 16/27; G05D 2201/0213; G07C 5/085

(57) ABSTRACT

Sensor data is accessed, which was generated sensors of a device in an environment. An observation of an event is determined, from the sensor data, that identifies movement of one or more machines within the environment in association with the event, where at least one of the machines is configured to move autonomously. Observation data is generated to describe the observation. The observation data is caused to be stored in a distributed linked data structure.

### TECHNICAL FIELD

This disclosure relates in general to the field of computer systems and, more particularly, to computing systems assessing safety of autonomous vehicles.

### BACKGROUND

Some vehicles are configured to operate in an autonomous mode in which the vehicle navigates through an environment with little or no input from a driver. Such a vehicle typically includes one or more sensors that are configured to sense information about the environment. The vehicle may use the sensed information to navigate through the environment. For example, if the sensors sense that the vehicle is approaching an obstacle, the vehicle may navigate around the obstacle.

### BRIEF DESCRIPTION OF THE DRAWINGS

FIG. 1 is a simplified block diagram of an example driving environment.

FIG. 2 is a simplified block diagram of an example in-vehicle automated driving system.

FIG. 3 is a simplified block diagram illustrating automated driving levels.

FIG. 4 is a simplified block diagram illustrating operating principles of an automated driving system.

FIG. 5 is a simplified block diagram illustrating basic functions of automated driving systems.

FIG. 6 is a simplified block diagram illustrating components of an example automated driving system.

FIG. 7 is a simplified block diagram of an example distributed linked data structure.

FIG. 8 is a simplified block diagram illustrating an example safety event involving one or more autonomous vehicles.

FIG. 9 is a simplified block diagram illustrating example observations generated for a safety event.

FIG. 10 is a simplified block diagram illustrating addition of blocks to an example distributed linked data structure.

FIG. 11 is a flow diagram illustrating an example technique for generating observations of safety events.

FIG. 12 is a simplified block diagram illustrating observation consensus using an example distributed linked data structure.

FIG. 13 is a simplified block diagram illustrating example generation of a judgment for inclusion in an example distributed linked data structure.

FIG. 14 is a simplified block diagram illustrating example generation of a revised judgment for inclusion in an example distributed linked data structure.

FIG. 15 is a simplified block diagram illustrating example consensus generation of a judgment for inclusion in an example distributed linked data structure.

FIG. 16 is an example flow diagram illustrating an example distributed consensus for a safety event.

FIGS. 17A-17B are simplified flow diagrams illustrating techniques utilized in ascertaining safety-related events involving autonomous machines.

FIG. 18 is a block diagram of an exemplary processor in accordance with one embodiment.

FIG. 19 is a block diagram of an exemplary computing system in accordance with one embodiment.

Like reference numbers and designations in the various drawings indicate like elements.

### DESCRIPTION OF EXAMPLE EMBODIMENTS

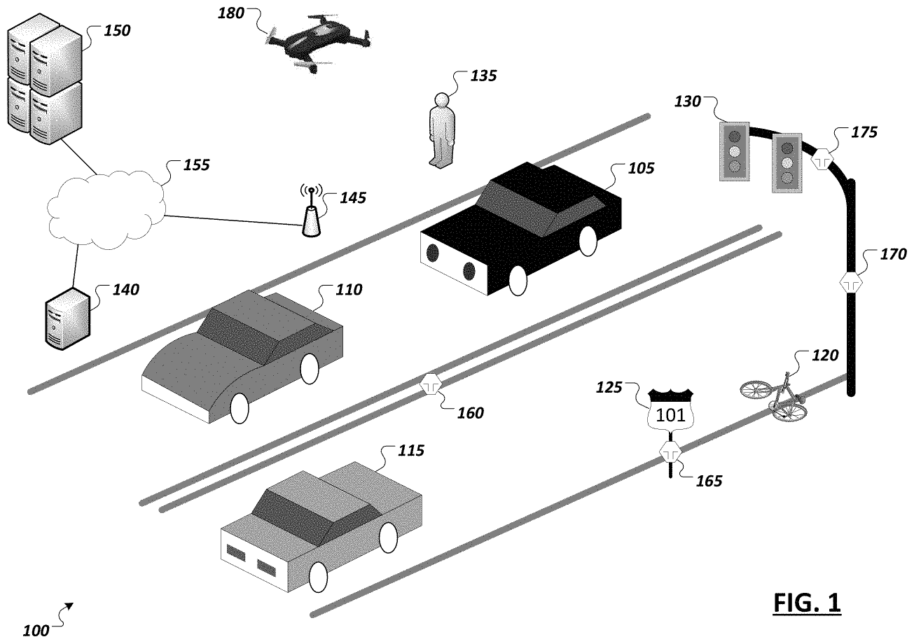

FIG. 1 is a simplified illustration 100 showing an example autonomous driving environment. Vehicles (e.g., 105, 110, 115, etc.) may be provided with varying levels of autonomous driving capabilities facilitated through in-vehicle computing systems with logic implemented in hardware, firmware, and/or software to enable respective autonomous driving stacks. Such autonomous driving stacks may allow vehicles to self-control or provide driver assistance to detect roadways, navigate from one point to another, detect other vehicles and road actors (e.g., pedestrians (e.g., 135), bicyclists, etc.), detect obstacles and hazards (e.g., 120), and road conditions (e.g., traffic, road conditions, weather conditions, etc.), and adjust control and guidance of the vehicle accordingly.

In some implementations, vehicles (e.g., 105, 110, 115) within the environment may be “connected” in that the in-vehicle computing systems include communication modules to support wireless communication using one or more technologies (e.g., IEEE 802.11 communications (e.g., WiFi), cellular data networks (e.g., 3rd Generation Partnership Project (3GPP) networks, Global System for Mobile Communication (GSM), general packet radio service, code division multiple access (CDMA), etc.), Bluetooth™, millimeter wave (mmWave), ZigBee™, Z-Wave™, etc.), allowing the in-vehicle computing systems to connect to and communicate with other computing systems, such as the in-vehicle computing systems of other vehicles, roadside units, cloud-based computing systems, or other supporting infrastructure. For instance, in some implementations, vehicles (e.g., 105, 110, 115) may communicate with computing systems providing sensors, data, and services in support of the vehicles' own autonomous driving capabilities. For instance, as shown in the illustrative example of FIG. 1, supporting drones 180 (e.g., ground-based and/or aerial), roadside computing devices (e.g., 140), various external (to the vehicle, or “extraneous”) sensor devices (e.g., 160, 165, 170, 175, etc.), and other devices may be provided as autonomous driving infrastructure separate from the computing systems, sensors, and logic implemented on the vehicles (e.g., 105, 110, 115) to support and improve autonomous driving results provided through the vehicles, among other examples. Vehicles may also communicate with other connected vehicles over wireless communication channels to share data and coordinate movement within an autonomous driving environment, among other example communications.

As illustrated in the example of FIG. 1, autonomous driving infrastructure may incorporate a variety of different systems. Such systems may vary depending on the location, with more developed roadways (e.g., roadways controlled by specific municipalities or toll authorities, roadways in urban areas, sections of roadways known to be problematic for autonomous vehicles, etc.) having a greater number or more advanced supporting infrastructure devices than other sections of roadway, etc. For instance, supplemental sensor devices (e.g., 160, 165, 170, 175) may be provided, which include sensors for observing portions of roadways and vehicles moving within the environment and generating corresponding data describing or embodying the observations of the sensors. As examples, sensor devices may be embedded within the roadway itself (e.g., sensor 160), on roadside or overhead signage (e.g., sensor 165 on sign 125), sensors (e.g., 170, 175) attached to electronic roadside equipment or fixtures (e.g., traffic lights (e.g., 130), electronic road signs, electronic billboards, etc.), dedicated road side units (e.g., 140), among other examples. Sensor devices may also include communication capabilities to communicate their collected sensor data directly to nearby connected vehicles or to fog- or cloud-based computing systems (e.g., 140, 150). Vehicles may obtain sensor data collected by external sensor devices (e.g., 160, 165, 170, 175, 180), or data embodying observations or recommendations generated by other systems (e.g., 140, 150) based on sensor data from these sensor devices (e.g., 160, 165, 170, 175, 180), and use this data in sensor fusion, inference, path planning, and other tasks performed by the in-vehicle autonomous driving system. In some cases, such extraneous sensors and sensor data may, in actuality, be within the vehicle, such as in the form of an after-market sensor attached to the vehicle, a personal computing device (e.g., smartphone, wearable, etc.) carried or worn by passengers of the vehicle, etc. Other road actors, including pedestrians, bicycles, drones, electronic scooters, etc., may also be provided with or carry sensors to generate sensor data describing an autonomous driving environment, which may be used and consumed by autonomous vehicles, cloud- or fog-based support systems (e.g., 140, 150), other sensor devices (e.g., 160, 165, 170, 175, 180), among other examples.

As autonomous vehicle systems may possess varying levels of functionality and sophistication, support infrastructure may be called upon to supplement not only the sensing capabilities of some vehicles, but also the computer and machine learning functionality enabling autonomous driving functionality of some vehicles. For instance, compute resources and autonomous driving logic used to facilitate machine learning model training and use of such machine learning models may be provided on the in-vehicle computing systems entirely or partially on both the in-vehicle systems and some external systems (e.g., 140, 150). For instance, a connected vehicle may communicate with road-side units, edge systems, or cloud-based devices (e.g., 140) local to a particular segment of roadway, with such devices (e.g., 140) capable of providing data (e.g., sensor data aggregated from local sensors (e.g., 160, 165, 170, 175, 180) or data reported from sensors of other vehicles), performing computations (as a service) on data provided by a vehicle to supplement the capabilities native to the vehicle, and/or push information to passing or approaching vehicles (e.g., based on sensor data collected at the device 140 or from nearby sensor devices, etc.). A connected vehicle (e.g., 105, 110, 115) may also or instead communicate with cloud-based computing systems (e.g., 150), which may provide similar memory, sensing, and computational resources to enhance those available at the vehicle. For instance, a cloud-based system (e.g., 150) may collect sensor data from a variety of devices in one or more locations and utilize this data to build and/or train machine-learning models which may be used at the cloud-based system (to provide results to various vehicles (e.g., 105, 110, 115) in communication with the cloud-based system 150, or to push to vehicles for use by their in-vehicle systems, among other example implementations. Access points (e.g., 145), such as cell-phone towers, road-side units, network access points mounted to various roadway infrastructure, access points provided by neighboring vehicles or buildings, and other access points, may be provided within an environment and used to facilitate communication over one or more local or wide area networks (e.g., 155) between cloud-based systems (e.g., 150) and various vehicles (e.g., 105, 110, 115). Through such infrastructure and computing systems, it should be appreciated that the examples, features, and solutions discussed herein may be performed entirely by one or more of such in-vehicle computing systems, fog-based or edge computing devices, or cloud-based computing systems, or by combinations of the foregoing through communication and cooperation between the systems.

In general, “servers,” “clients,” “computing devices,” “network elements,” “hosts,” “platforms”, “sensor devices,” “edge device,” “autonomous driving systems”, “autonomous vehicles”, “fog-based system”, “cloud-based system”, and “systems” generally, etc. discussed herein can include electronic computing devices operable to receive, transmit, process, store, or manage data and information associated with an autonomous driving environment. As used in this document, the term “computer,” “processor,” “processor device,” or “processing device” is intended to encompass any suitable processing apparatus, including central processing units (CPUs), graphical processing units (GPUs), application specific integrated circuits (ASICs), field programmable gate arrays (FPGAs), digital signal processors (DSPs), tensor processors and other matrix arithmetic processors, among other examples. For example, elements shown as single devices within the environment may be implemented using a plurality of computing devices and processors, such as server pools including multiple server computers. Further, any, all, or some of the computing devices may be adapted to execute any operating system, including Linux™, UNIX™, Microsoft™ Windows™, Apple™ macOS™, Apple™ (OS™, Google™ Android™, Windows Server™, etc., as well as virtual machines adapted to virtualize execution of a particular operating system, including customized and proprietary operating systems.

Any of the flows, methods, processes (or portions thereof) or functionality of any of the various components described below or illustrated in the figures may be performed by any suitable computing logic, such as one or more modules, engines, blocks, units, models, systems, or other suitable computing logic. Reference herein to a “module”, “engine”, “block”, “unit”, “model”, “system” or “logic” may refer to hardware, firmware, software and/or combinations of each to perform one or more functions. As an example, a module, engine, block, unit, model, system, or logic may include one or more hardware components, such as a micro-controller or processor, associated with a non-transitory medium to store code adapted to be executed by the micro-controller or processor. Therefore, reference to a module, engine, block, unit, model, system, or logic, in one embodiment, may refer to hardware, which is specifically configured to recognize and/or execute the code to be held on a non-transitory medium. Furthermore, in another embodiment, use of module, engine, block, unit, model, system, or logic refers to the non-transitory medium including the code, which is specifically adapted to be executed by the microcontroller or processor to perform predetermined operations. And as can be inferred, in yet another embodiment, a module, engine, block, unit, model, system, or logic may refer to the combination of the hardware and the non-transitory medium. In various embodiments, a module, engine, block, unit, model, system, or logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. A module, engine, block, unit, model, system, or logic may include one or more gates or other circuit components, which may be implemented by, e.g., transistors. In some embodiments, a module, engine, block, unit, model, system, or logic may be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. Furthermore, logic boundaries that are illustrated as separate commonly vary and potentially overlap. For example, a first and second module (or multiple engines, blocks, units, models, systems, or logics) may share hardware, software, firmware, or a combination thereof, while potentially retaining some independent hardware, software, or firmware.

The flows, methods, and processes described below and in the accompanying figures are merely representative of functions that may be performed in particular embodiments. In other embodiments, additional functions may be performed in the flows, methods, and processes. Various embodiments of the present disclosure contemplate any suitable signaling mechanisms for accomplishing the functions described herein. Some of the functions illustrated herein may be repeated, combined, modified, or deleted within the flows, methods, and processes where appropriate. Additionally, functions may be performed in any suitable order within the flows, methods, and processes without departing from the scope of particular embodiments.

Currently traffic accidents usually involve one or several vehicles controlled by human drivers. After the accident takes place each involved road user reports the observation of the events that lead to the accident with the optional presence of other witnesses of the event. A claim process may then begin with insurers and/or public safety administrators, in some cases resulting in the claim being adjudicated in a court of law. With the advent of automation brings the possibility of accidents happening where one, several, or even all the involved actors and witnesses (also referred to herein as “agents”) are autonomous vehicles. In such circumstances, it may be impracticable, undesirable, or insufficient to apply current claim processes developed around human users and witnesses. With the deployment of autonomous vehicles, circumstances may soon arise where no human operators are involved and/or where no human witness was present and thus able to provide judgment based on presence observations. Accordingly, computing systems utilized to provide or support autonomous driving functionality may be enhanced to enable appropriate reporting and judging safety critical performance of automated driving vehicles. In modern practice, when accidents occur, human actors and witnesses are largely relied upon to give their assessment of whether correct and legal driving practices were being followed by those involved in the accident. Their observations may be supplemented and corroborated/called into question by reconstructing events utilizing modern scientific and forensic information, whether the collective evidence is utilized to judge the cause of the accident according to the rule of law.

While it is anticipated by many thought leaders that the rate and severity of automobile accidents is likely to decrease and autonomous vehicles replace manually operated vehicles on streets and highways, it is also accepted that some accidents will nonetheless be unavoidable and inevitable. The problem of safety is not “can we build an autonomous vehicle that doesn't have accidents?”, but instead “can we build one that doesn't get into accidents by its own decision-making?” Models may be provided and adopted within the logic of automated driving systems, the models serving to formalize definitions of what level of safety and automated driving behavior is acceptable. Such models may define an industry standard on safe road behaviors (e.g., starting with longitudinal and lateral maneuvers) and include definitions such as safe distance, time to collision, right of way and responsibility to be commonly agreed and defined for automated driving vehicles to operate in a particular geopolitical location. As one example, the Responsibility Sensitive Safety model (RSS) (e.g., based on Shai Shalev-Shwartz, et al., On a Formal Model of Safe and Scalable Self-driving Cars, 2017) introduces the concepts of common sense, cautious driving, blame and proper response and defines the mathematical proofs for a number of road environments. In theory, such a model defines a set of universally adaptable rules for autonomous driving systems, such that if an automated vehicle follows these common sense rules and applies cautious driving and proper responses, the autonomous vehicle should not be the cause of an accident (e.g., reducing the universe of accidents to those due to a human error, unpredictable disaster, or malfunction of a computing system utilized in making autonomous driving decisions, etc. rather than the correctly functioning of autonomous driving systems of autonomous vehicles on the road). Such models may define rules that model optimal driving behavior for providing comfortable and reliable travel while minimizing accidents and, in some cases, be based or require adherence to active regulations (e.g., follow the maximum driving limit of the road segment, comply with traffic signs and lane markings, etc.). In short, a goal of autonomous driving systems is to automate vehicles such that the vehicle follows all regulations and if a traffic incident does happen, it should not be the fault of the autonomous driving system logic.

In some implementations, a consensus-based verification of automated vehicle compliance to regulations may be implemented utilizing an improved safety system, for instance, to collect and report information associated with safety-critical road events such as car accidents and leverage processing logic available at multiple computing systems observing the relevant scene to determine the characteristics and causes of the event. In some implementations, consensus determinations may be stored in trusted, shared datastores, such as cryptographically secured distributed ledgers, such as records utilizing blockchain technology. For instance, a blockchain-based list of records may be utilized to store road events and achieve consensus among non-trusting parties based on the stored observations of the event. In such instances, the computing systems of participating road agents (e.g., automated vehicles, intelligent intersection sensors, roadside structures and sensors, drones monitoring roadways, non-autonomous vehicles, other road users, etc.) may be configured to submit the analysis of a traffic event determined at the agent from their respective point of view, the analysis identifying conclusions of the agent regarding whether the involved vehicle(s) behavior adhered to regulations or safety conventions. Accordingly, a consensus-based analysis of the observations that may be stored in the blockchain. The raw sensor data utilized by the agents in reaching their observations and conclusions regarding an event may also be stored with the observations as evidence supporting the validity and/or trustworthiness of a given agent's determinations. The consensus observations may be used as transparent and verifiable proof between non-trusted parties such as individual claimers, insurance companies, government organizations and other interested parties, among other example uses.

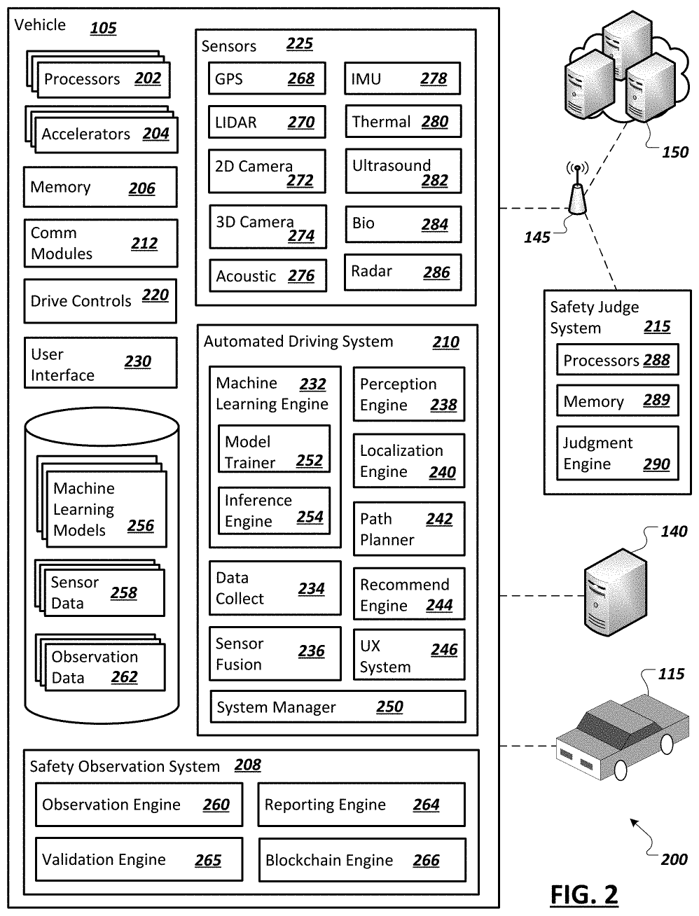

Systems may be developed to implement the example solutions introduced above. For instance, with reference now to FIG. 2, a simplified block diagram 200 is shown illustrating an example implementation of a vehicle (and corresponding in-vehicle computing system) 105 equipped with autonomous driving functionality. In one example, a vehicle 105 may be equipped with one or more processors 202, such as central processing units (CPUs), graphical processing units (GPUs), application specific integrated circuits (ASICs), field programmable gate arrays (FPGAs), digital signal processors (DSPs), tensor processors and other matrix arithmetic processors, among other examples. Such processors 202 may be coupled to or have integrated hardware accelerator devices (e.g., 204), which may be provided with hardware to accelerate certain processing and memory access functions, such as functions relating to machine learning inference or training (including any of the machine learning inference or training described below), processing of particular sensor data (e.g., camera image data, Light Detecting and Ranging (LIDAR) point clouds, etc.), performing certain arithmetic functions pertaining to autonomous driving (e.g., matrix arithmetic, convolutional arithmetic, etc.), among other examples. One or more memory elements (e.g., 206) may be provided to store machine-executable instructions implementing all or a portion of any one of the modules or sub-modules of an autonomous driving stack implemented on the vehicle, as well as storing machine learning models (e.g., 256), sensor data (e.g., 258), and other data received, generated, or used in connection with autonomous driving functionality to be performed by the vehicle (or used in connection with the examples and solutions discussed herein). Various communication modules (e.g., 212) may also be provided, implemented in hardware circuitry and/or software to implement communication capabilities used by the vehicle's system to communicate with other extraneous computing systems over one or more network channels employing one or more network communication technologies. These various processors 202, accelerators 204, memory devices 206, and network communication modules 212, may be interconnected on the vehicle system through a variety of interfaces implemented, for instance, through one or more interconnect fabrics or links, such as fabrics utilizing technologies such as a Peripheral Component Interconnect Express (PCIe), Ethernet, Universal Serial Bus (USB), Ultra Path Interconnect (UPI), Controller Area Network (CAN) bus, among others.

Continuing with the example of FIG. 2, an example vehicle (and corresponding in-vehicle computing system) 105 may include an in-vehicle automated driving system 210, driving controls (e.g., 220), sensors (e.g., 225), and user/passenger interface(s) (e.g., 230), among other example modules implemented functionality of the autonomous vehicle in hardware and/or software. For instance, an automated driving system 210, in some implementations, may implement all or a portion of an autonomous driving stack and process flow. In some implementations, the automated driving system 210 may be based on and designed to operate in accordance with a standardized safety model, such as an RSS-based model. A machine learning engine 232 may be provided to utilize various machine learning models (e.g., 256) provided at the vehicle 105 in connection with one or more autonomous functions and features provided and implemented at or for the vehicle, such as discussed in the examples herein. Such machine learning models 256 may include artificial neural network models, convolutional neural networks, decision tree-based models, support vector machines (SVMs), Bayesian models, deep learning models, and other example models. In some implementations, an example machine learning engine 232 may include one or more model trainer engines 252 to participate in training (e.g., initial training, continuous training, etc.) of one or more of the machine learning models 256. One or more inference engines 254 may also be provided to utilize the trained machine learning models 256 to derive various inferences, predictions, classifications, and other results. In some embodiments, the machine learning model training or inference described herein may be performed off-vehicle, such as by computing system 140 or 150.

The machine learning engine(s) 232 provided at the vehicle may be utilized to support and provide results for use by other logical components and modules of the automated driving system 210 implementing an autonomous driving stack and other autonomous-driving-related features. For instance, a data collection module 234 may be provided with logic to determine sources from which data is to be collected (e.g., for inputs in the training or use of various machine learning models 256 used by the vehicle). For instance, the particular source (e.g., internal sensors (e.g., 225) or extraneous sources (e.g., 115, 140, 150, etc.)) may be selected, as well as the frequency and fidelity at which the data may be sampled is selected. In some cases, such selections and configurations may be made at least partially autonomously by the data collection module 234 using one or more corresponding machine learning models (e.g., to collect data as appropriate given a particular detected scenario).

A sensor fusion module 236 may also be used to govern the use and processing of the various sensor inputs utilized by the machine learning engine 232 and other modules (e.g., 238, 240, 242, 244, 246, etc.) of the in-vehicle processing system. One or more sensor fusion modules (e.g., 236) may be provided, which may derive an output from multiple sensor data sources (e.g., on the vehicle or extraneous to the vehicle). The sources may be homogenous or heterogeneous types of sources (e.g., multiple inputs from multiple instances of a common type of sensor, or from instances of multiple different types of sensors). An example sensor fusion module 236 may apply direct fusion, indirect fusion, among other example sensor fusion techniques. The output of the sensor fusion may, in some cases by fed as an input (along with potentially additional inputs) to another module of the in-vehicle processing system and/or one or more machine learning models in connection with providing autonomous driving functionality or other functionality, such as described in the example solutions discussed herein.

A perception engine 238 may be provided in some examples, which may take as inputs various sensor data (e.g., 258) including data, in some instances, from extraneous sources and/or sensor fusion module 236 to perform object recognition and/or tracking of detected objects, among other example functions corresponding to autonomous perception of the environment encountered (or to be encountered) by the vehicle 105. Perception engine 238 may perform object recognition from sensor data inputs using deep learning, such as through one or more convolutional neural networks and other machine learning models 256. Object tracking may also be performed to autonomously estimate, from sensor data inputs, whether an object is moving and, if so, along what trajectory. For instance, after a given object is recognized, a perception engine 238 may detect how the given object moves in relation to the vehicle. Such functionality may be used, for instance, to detect objects such as other vehicles, pedestrians, wildlife, cyclists, etc. moving within an environment, which may affect the path of the vehicle on a roadway, among other example uses.

A localization engine 240 may also be included within an automated driving system 210 in some implementation. In some cases, localization engine 240 may be implemented as a sub-component of a perception engine 238. The localization engine 240 may also make use of one or more machine learning models 256 and sensor fusion (e.g., of LIDAR and GPS data, etc.) to determine a high confidence location of the vehicle and the space it occupies within a given physical space (or “environment”).

A vehicle 105 may further include a path planner 242, which may make use of the results of various other modules, such as data collection 234, sensor fusion 236, perception engine 238, and localization engine (e.g., 240) among others (e.g., recommendation engine 244) to determine a path plan and/or action plan for the vehicle, which may be used by drive controls (e.g., 220) to control the driving of the vehicle 105 within an environment. For instance, a path planner 242 may utilize these inputs and one or more machine learning models to determine probabilities of various events within a driving environment to determine effective real-time plans to act within the environment.

In some implementations, the vehicle 105 may include one or more recommendation engines 244 to generate various recommendations from sensor data generated by the vehicle's 105 own sensors (e.g., 225) as well as sensor data from extraneous sensors (e.g., on sensor devices 115, etc.). Some recommendations may be determined by the recommendation engine 244, which may be provided as inputs to other components of the vehicle's autonomous driving stack to influence determinations that are made by these components. For instance, a recommendation may be determined, which, when considered by a path planner 242, causes the path planner 242 to deviate from decisions or plans it would ordinarily otherwise determine, but for the recommendation. Recommendations may also be generated by recommendation engines (e.g., 244) based on considerations of passenger comfort and experience. In some cases, interior features within the vehicle may be manipulated predictively and autonomously based on these recommendations (which are determined from sensor data (e.g., 258) captured by the vehicle's sensors and/or extraneous sensors, etc.

As introduced above, some vehicle implementations may include user/passenger experience engines (e.g., 246), which may utilize sensor data and outputs of other modules within the vehicle's autonomous driving stack to cause driving maneuvers and changes to the vehicle's cabin environment to enhance the experience of passengers within the vehicle based on the observations captured by the sensor data (e.g., 258). In some instances, aspects of user interfaces (e.g., 230) provided on the vehicle to enable users to interact with the vehicle and its autonomous driving system may be enhanced. In some cases, informational presentations may be generated and provided through user displays (e.g., audio, visual, and/or tactile presentations) to help affect and improve passenger experiences within a vehicle (e.g., 105) among other example uses.

In some cases, a system manager 250 may also be provided, which monitors information collected by various sensors on the vehicle to detect issues relating to the performance of a vehicle's autonomous driving system. For instance, computational errors, sensor outages and issues, availability and quality of communication channels (e.g., provided through communication modules 212), vehicle system checks (e.g., issues relating to the motor, transmission, battery, cooling system, electrical system, tires, etc.), or other operational events may be detected by the system manager 250. Such issues may be identified in system report data generated by the system manager 250, which may be utilized, in some cases as inputs to machine learning models 256 and related autonomous driving modules (e.g., 232, 234, 236, 238, 240, 242, 244, 246, etc.) to enable vehicle system health and issues to also be considered along with other information collected in sensor data 258 in the autonomous driving functionality of the vehicle 105. In some implementations, safety manager 250 may implement or embody an example safety companion subsystem, among other example features.

In some implementations, an autonomous driving stack of a vehicle 105 may be coupled with drive controls 220 to affect how the vehicle is driven, including steering controls, accelerator/throttle controls, braking controls, signaling controls, among other examples. In some cases, a vehicle may also be controlled wholly or partially based on user inputs. For instance, user interfaces (e.g., 230), may include driving controls (e.g., a physical or virtual steering wheel, accelerator, brakes, clutch, etc.) to allow a human driver to take control from the autonomous driving system (e.g., in a handover or following a driver assist action). Other sensors may be utilized to accept user/passenger inputs, such as speech detection, gesture detection cameras, and other examples. User interfaces (e.g., 230) may capture the desires and intentions of the passenger-users and the autonomous driving stack of the vehicle 105 may consider these as additional inputs in controlling the driving of the vehicle (e.g., drive controls 220). In some implementations, drive controls may be governed by external computing systems, such as in cases where a passenger utilizes an external device (e.g., a smartphone or tablet) to provide driving direction or control, or in cases of a remote valet service, where an external driver or system takes over control of the vehicle (e.g., based on an emergency event), among other example implementations. User interfaces 230 provided may also present information to user-passengers of a vehicle and may include display screens, speakers, and other interfaces to present visual or audio status information to users, among other examples.

As discussed above, the autonomous driving stack of a vehicle may utilize a variety of sensor data (e.g., 258) generated by various sensors provided on and external to the vehicle. As an example, a vehicle 105 may possess an array of sensors 225 to collect various information relating to the exterior of the vehicle and the surrounding environment, vehicle system status, conditions within the vehicle, and other information usable by the modules of the vehicle's automated driving system 210. For instance, such sensors 225 may include global positioning (GPS) sensors 268, light detection and ranging (LIDAR) sensors 270, two-dimensional (2D) cameras 272, three-dimensional (3D) or stereo cameras 274, acoustic sensors 276, inertial measurement unit (IMU) sensors 278, thermal sensors 280, ultrasound sensors 282, bio sensors 284 (e.g., facial recognition, voice recognition, heart rate sensors, body temperature sensors, emotion detection sensors, etc.), radar sensors 286, weather sensors (not shown), among other example sensors. Sensor data 258 may also (or instead) be generated by sensors that are not integrally coupled to the vehicle, including sensors on other vehicles (e.g., 115) (which may be communicated to the vehicle 105 through vehicle-to-vehicle communications or other techniques), sensors on ground-based or aerial drones, sensors of user devices (e.g., a smartphone or wearable) carried by human users inside or outside the vehicle 105, and sensors mounted or provided with other roadside elements, such as a roadside unit (e.g., 140), road sign, traffic light, streetlight, etc. Sensor data from such extraneous sensor devices may be provided directly from the sensor devices to the vehicle or may be provided through data aggregation devices or as results generated based on these sensors by other computing systems (e.g., 140, 150), among other example implementations.

In some implementations, an autonomous vehicle system 105 may interface with and leverage information and services provided by other computing systems to enhance, enable, or otherwise support the autonomous driving functionality of the device 105. In some instances, some autonomous driving features (including some of the example solutions discussed herein) may be enabled through services, computing logic, machine learning models, data, or other resources of computing systems external to a vehicle. When such external systems are unavailable to a vehicle, it may be that these features are at least temporarily disabled. For instance, external computing systems may be provided and leveraged, which are hosted in road-side units or fog-based edge devices (e.g., 140), other (e.g., higher-level) vehicles (e.g., 115), and cloud-based systems 150 (e.g., accessible through various network access points (e.g., 145)). A roadside unit 140 or cloud-based system 150 (or other cooperating system, with which a vehicle (e.g., 105) interacts may include all or a portion of the logic illustrated as belonging to an example in-vehicle automated driving system (e.g., 210), along with potentially additional functionality and logic. For instance, a cloud-based computing system, road side unit 140, or other computing system may include a machine learning engine supporting either or both model training and inference engine logic. For instance, such external systems may possess higher-end computing resources and more developed or up-to-date machine learning models, allowing these services to provide superior results to what would be generated natively on a vehicle's automated driving system 210. For instance, an automated driving system 210 may rely on the machine learning training, machine learning inference, and/or machine learning models provided through a cloud-based service for certain tasks and handling certain scenarios. Indeed, it should be appreciated that one or more of the modules discussed and illustrated as belonging to vehicle 105 may, in some implementations, be alternatively or redundantly provided within a cloud-based, fog-based, or other computing system supporting an autonomous driving environment.

As discussed, a vehicle, roadside unit, or other agent may collect a variety of information using a variety of sensors. Such data may be accessed or harvested in connection with a critical road event involving an autonomous vehicle. However, such raw data may be extensive and pose an onerous requirement on the telematics system of a vehicle tasked with providing this information to other systems for storage or further analytics. While such raw sensor data, provided potentially by multiple different agents in connection with an event, may be aggregated and processed by a single centralized system, such an implementation may raise issues of trust with the centralized processor and involve complicated filtering and sensor fusion analytics in order to make a determination regarding the causes and factors associated with the related safety event. Additionally, centralizing event analytics using raw sensor data may be slow and ineffective given the data transfers involved.

In an improved system, such as discussed in examples herein, critical observations may be made using the autonomous driving logic resident on the various road agents involved or witnessing an event and the observation results may be reported by the road agents nearly contemporaneously with the occurrence of the event. Such observation result data may be reported, for instance, by writing each of the observations to a blockchain-based (e.g., rather than the raw sensor data underlying the observations), which may reduce the bandwidth used for such transactions and enable trusted, consensus-based adjudication of the event. Indeed, the use (and transmission) of the underlying raw data may be foregone completely. Further, a blockchain-based distributed database may additionally cryptographic proof of critical observations and analysis of safety performance by all actors involved or witnessing an accident. These observations may then stand as part of a public (distributed) chain, which cannot be tampered with. Consensus on compliance to regulations by each actor involved in the event may be then achieved using the blockchain records of the event (e.g., by trusted, downstream actors). Further, judgments based on the observations may be updated as additional observations are delivered (e.g., by other agents). Ultimately, the analysis of the observations can be used to disclose that a certain actor (or actors) is/are to be blamed for a given event (e.g., accident).

In some implementations, automated driving vehicles and other road agents are configured to perform trusted safety observations of traffic events, which could or could not involve themselves (actor or witness) into a verifiable distributed database in the form of a block-chain. In some instances, observations determined by the agents are performed using logic based on a standardize safety decision making model (e.g., RSS) or other rule-based logic embedding traffic regulations and driving standards. These observations may be stored in a blockchain for use in assessing the compliance to safety regulations of all vehicles involved in an incident. Furthermore, consensus on the observations of the incident by multiple agents can be determined (manually or utilizing computing logic (e.g., machine learning) and the consensus safely stored (e.g., with the underlying observations) on the blockchain.

Continuing with the discussion of FIG. 2, in some implementations, an example agent, such as vehicle 105, may include functionality to allow the agent to contribute their observations of a road event into a public, distributed database (e.g., based on blockchain) to ensure that accident observations are recorded from the agents involved in the critical road event (e.g., accident, traffic violation, criminal act, etc.) and/or are possible witnesses to the cause and circumstances surrounding the event. Such a system may enable the generation of a secure and tamper-proof record of the events where no human eyes might be present. For instance, one or more multiple agents present at the scene of an accident may each be equipped with a respective safety observation system (e.g., 208) configured to process sensor data generated at or otherwise accessed by the agent and determine an evaluation of regulation compliance associated with the particular event. The results of this evaluation (e.g., embodied as observation data (e.g., 262) may be loaded into the distributed database (e.g., a public blockchain) hosted on a number of computing systems in a network (e.g., 150). The observations provided to the distributed database may then be utilized to determine consensus of these observations, which may be utilized to provide a scalable, secure, publicly-verifiable and tamper-proof testimony that can be used, for instance, in connection with legal, maintenance, and/or insurance claims resulting from the event.

For instance, an example safety observation engine 208 may leverage logic of an automated driving system 210, such as logic utilized to implement a standardized driving standard (e.g., RSS), as well as the sensors 225 of the vehicle 105 to determine observations in connection with safety events detected by the vehicle 105. A safety event may be an event that directly involves the vehicle 105 or may involve vehicles (e.g., 115), property, persons, animals, etc. outside the vehicle 105 (but which the vehicle's sensors 225 may have at least partially observed). An event may be detected automatically, for instance, based on collision or other sensors or systems present on a vehicle involved in the event or other systems (e.g., drones, roadside sensors, etc.) witnessing the event. Detection of an event may result in a signal being broadcast for reception by nearby systems to preserve sensor data (e.g., 258) generated contemporaneously with the event. In other cases, presence of an agent (e.g., 105, 115, etc.) may be documented in response to detection of an event and each agent may be later requested to provide information regarding the event at a later time (e.g., by drawing on the sensor data (e.g., 258) recorded and stored relating to the event), among other examples. In some implementations, an observation engine (e.g., 260) may determine one or more conclusions, or observations, relating to conditions and behaviors of entities involved in the event from the sensor data (e.g., 258) generated by the agent's sensors contemporaneously with the occurrence of the event. In some implementations, the observations determined using the observation engine (and the observation engine's logic itself) may be based on an automated driving safety model (e.g., RSS), such that the observations identify characteristics of the involved entities' behavior leading up to and after the event that relate to defined behaviors and practices in the safety model. For instance, an observation engine 260 may identify that an event has occurred (e.g., based on internal detection of the event by systems of vehicle 105, or in response to a notification of the event's occurrence transmitted by an external source) and identify sensor data 258 generated by sensor 225 within a window of time coinciding with the lead-up and occurrence of the event. From this selection of sensor data, the observation engine 260 may determine speeds of other vehicles, lateral movement of other vehicles or actors, status of traffic signals, brake lights, and other attributes and further determine whether the actions of entities involved in the event were in compliance with one or more safety rules or standards defined by a safety model, among other examples. Observations determined by the observation engine 260 may be embodied in observation data 262 and may be reported for storage in a secure datastore (e.g., using reporting engine 264), such as a blockchain-based, public, distributed database. Observation data 262 can be further reported to the systems of other interested parties, such as the vehicle manufacturer, the vendor(s) responsible for the automated driving system, an insurance company, etc. using the reporting engine 264, among other examples.

In some implementations, prior to allowing an observation to be recorded in a distributed database (e.g., implemented in a network of computing systems (e.g., 150)) may be first subjected to a validation screening, for instance, to determine the trustworthiness of the observation, enforce geofencing of sources of the observation (e.g., limiting observations to those generated by systems within the location of the event), enforce formatting rules, enforce security policies, among other rules and policies. In some implementations, validation may be limited to previously authorized systems. For instance, validated observations may be signed by a key, include a particular hash value, or include other cryptographic security data to identify that the observation was validated by a trusted system (e.g., equipped with trusted hardware or provisioned with the requisite cryptographic key(s) by a trusted authority). In some implementations, the safety observation system 208 (or separate systems of the vehicle 105 configured with corresponding logic) can include logic to perform validation of observations determined by the observation engine 260. For instance, as shown in FIG. 2, a safety observation system 208 may optionally include a validation engine 265. In other instances, the reporting engine 264 may report the observation data 262 generated by the observation engine 260 to a separate system (e.g., external to the vehicle 105) to perform the validation and ultimately record the validated observation in the distributed database. In implementations such as shown in the example of FIG. 2, the vehicle 105 can effectively self-validate and perform the loading of the observation data in a block of a blockchain-based distributed database (e.g., through creation of a new block for the database including the observation), directly at the vehicle as well (e.g., utilizing blockchain engine 266, among other example implementations.

Observations loaded into a distributed data structure (e.g., a distributed linked data structure, such as a blockchain-based data structure) may be utilized by other actors to ascertain the causes, circumstances, and conditions of a related safety event. In some implementations, such as shown in the example of FIG. 2, one or more safety judge systems 215 may be utilized to read the records of the distributed data structure and find observation data corresponding to observations generated by one or more agents' safety observation systems describing a particular event. In one example, a safety judge system 215 includes one or more processors (e.g., 288), one or more memory elements (e.g., 289), and logic, executable by the one or more processors (e.g., 288) embodying a judgment engine (e.g., 290) configured to perform a consensus algorithm using an event's observations as inputs. A judgment may be determined from the observations obtained from the distributed data structure, the judgment representing a consensus observation for the circumstances, conditions, and/or cause of the event. Judgment data may be generated and also appended to the distributed data structure such that both the observation data and the related judgment data are securely and reliable contained in the same distributed data structure, among other example implementations.

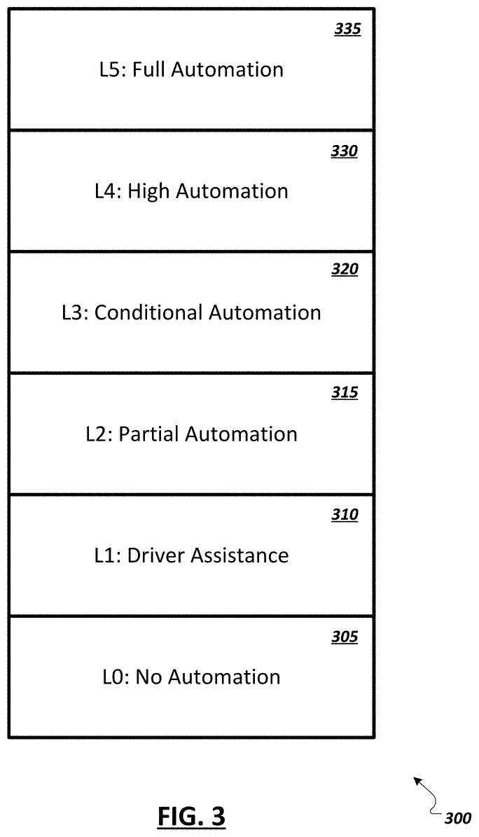

Turning to FIG. 3, a simplified block diagram 300 is shown illustrating example levels of autonomous driving, which may be supported in various vehicles (e.g., by their corresponding in-vehicle computing systems. For instance, a range of levels may be defined (e.g., L0-L5 (405-435)), with level 5 (L5) corresponding to vehicles with the highest level of autonomous driving functionality (e.g., full automation), and level 0 (L0) corresponding the lowest level of autonomous driving functionality (e.g., no automation). For instance, an L5 vehicle (e.g., 335) may possess a fully-autonomous computing system capable of providing autonomous driving performance in every driving scenario equal to or better than would be provided by a human driver, including in extreme road conditions and weather. An L4 vehicle (e.g., 330) may also be considered fully-autonomous and capable of autonomously performing safety-critical driving functions and effectively monitoring roadway conditions throughout an entire trip from a starting location to a destination. L4 vehicles may differ from L5 vehicles, in that an L4's autonomous capabilities are defined within the limits of the vehicle's “operational design domain,” which may not include all driving scenarios. L3 vehicles (e.g., 320) provide autonomous driving functionality to completely shift safety-critical functions to the vehicle in a set of specific traffic and environment conditions, but which still expect the engagement and availability of human drivers to handle driving in all other scenarios. Accordingly, L3 vehicles may provide handover protocols to orchestrate the transfer of control from a human driver to the autonomous driving stack and back. L2 vehicles (e.g., 315) provide driver assistance functionality, which allow the driver to occasionally disengage from physically operating the vehicle, such that both the hands and feet of the driver may disengage periodically from the physical controls of the vehicle. L1 vehicles (e.g., 310) provide driver assistance of one or more specific functions (e.g., steering, braking, etc.), but still require constant driver control of most functions of the vehicle. L0 vehicles may be considered not autonomous—the human driver controls all of the driving functionality of the vehicle (although such vehicles may nonetheless participate passively within autonomous driving environments, such as by providing sensor data to higher level vehicles, using sensor data to enhance GPS and infotainment services within the vehicle, etc.). In some implementations, a single vehicle may support operation at multiple autonomous driving levels. For instance, a driver may control and select which supported level of autonomy is used during a given trip (e.g., L4 or a lower level). In other cases, a vehicle may autonomously toggle between levels, for instance, based on conditions affecting the roadway or the vehicle's autonomous driving system. For example, in response to detecting that one or more sensors have been compromised, an L5 or L4 vehicle may shift to a lower mode (e.g., L2 or lower) to involve a human passenger in light of the sensor issue, among other examples.

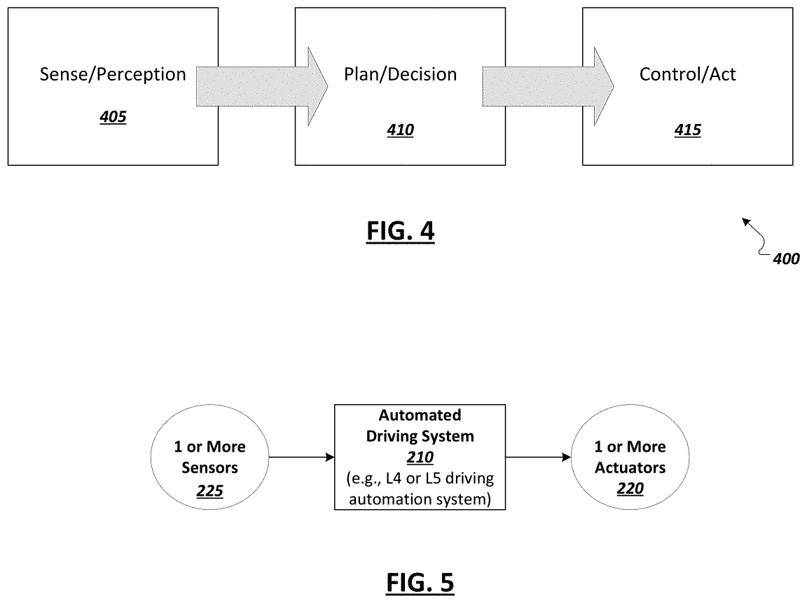

FIG. 4 is a simplified block diagram 400 illustrating an example autonomous driving flow which may be implemented in some autonomous driving systems. For instance, an autonomous driving flow implemented in an autonomous (or semi-autonomous) vehicle may include a sensing and perception stage 405, a planning and decision stage 410, and a control and action phase 415. During a sensing and perception stage 405 data is generated by various sensors and collected for use by the autonomous driving system. Data collection, in some instances, may include data filtering and receiving sensor from external sources. This stage may also include sensor fusion operations and object recognition and other perception tasks, such as localization, performed using one or more machine learning models. A planning and decision stage 410 may utilize the sensor data and results of various perception operations to make probabilistic predictions of the roadway(s) ahead and determine a real time path plan based on these predictions. A planning and decision stage 410 may additionally include making decisions relating to the path plan in reaction to the detection of obstacles and other events to decide on whether and what action to take to safely navigate the determined path in light of these events. Based on the path plan and decisions of the planning and decision stage 410, a control and action stage 415 may convert these determinations into actions, through actuators to manipulate driving controls including steering, acceleration, and braking, as well as secondary controls, such as turn signals, sensor cleaners, windshield wipers, headlights, etc. Accordingly, as illustrated in FIG. 5, the general function of an automated driving system 210 may utilize the inputs of a one or more sensors devices 225 (e.g., multiple sensors of multiple different types) and process these inputs to make a determination for the automated driving of a vehicle. To realize the performance of the automated driving (e.g., acceleration, steering, braking, signaling, etc.), the automated driving system 210 may generate one or more output signals to implement the determining automated driving actions and send these signals to one or more driving controls, or more generally “actuators” 220, utilized to cause the corresponding vehicle to perform these driving actions.

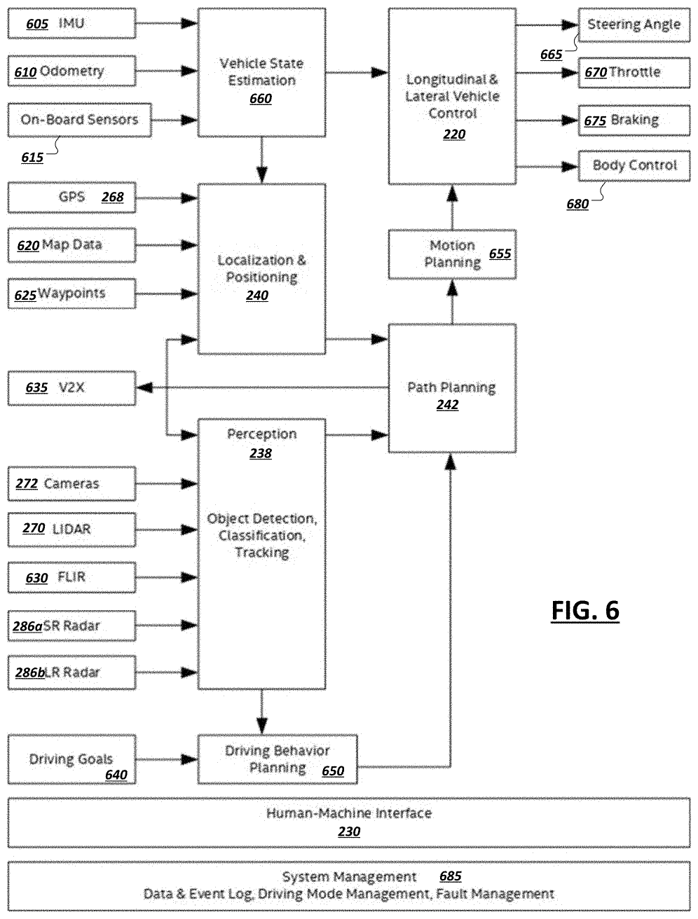

FIG. 6 is a simplified block diagram illustrating the example interaction of components and logic used to implement an in-vehicle automated driving system in accordance with one example implementation. For instance, a variety of sensors and logic may be provided which may generate data that may be used by the automated driving system, such as inertial measurement units (IMUS) 605, odometry logic 610, on-board sensors 615, GPS sensors 268, map data 620, waypoint data and logic (e.g., 625), cameras (e.g., 272), LIDAR sensors 270, short range radar sensors 286a, long range radar sensors 286b, forward-looking infrared (FLIR) sensor 630, among other example sensors. Additional information may be provided from sources external to the vehicle (e.g., through a network facilitating vehicle-to-everything (V2X) communications (e.g., 635)) or from the user of the vehicle (e.g., driving goals (e.g., 640) or other inputs provided by passengers within the vehicle (e.g., through human-machine interfaces (e.g., 230)). Some of these inputs may be provided to a perception engine 238, which may assess the information included in sensor data generated by one or a combination of the vehicle's sensors (or even external (e.g., roadside) sensors) and perform object detection (e.g., to identify potential hazards and road characteristics), classify the objects (e.g., to determine whether they are hazards or not), and track objects (e.g., to determine and predict movement of the objects and ascertain whether or when the objects should impact the driving of the vehicle).

Other sensors and logic (e.g., 268, 620, 625, etc.) may be fed to localization and positioning logic (e.g., 240) of the automated driving system to enable accurate and precise localization of the vehicle by the automated driving system (e.g., to understand the geolocation of the vehicle, as well as its position relative to certain actual or anticipated hazards, etc.). Results of the perception engine 230 and localization engine 240 may be utilized together by path planning logic 242 of the automated driving system, such that the vehicle self-navigates toward a desired outcome, while more immediately doing so in a safe manner. Driving behavior planning logic (e.g., 650) may also be provided in some implementations to consider driving goals (e.g., system-level or user-customized goals) to deliver certain driving or user comfort expectations (e.g., speed, comfort, traffic avoidance, toll road avoidance, prioritization of scenic routes or routes that keep the vehicle within proximity of certain landmarks or amenities, etc.). The output of the driving behavior planning module 650 may also be fed into and be considered by a path planning engine 242 in determining the most desirable path for the vehicle.

A path planning engine 242 may decide on the path to be taken by a vehicle, with a motion planning engine 655 tasked with determining “how” to realize this path (e.g., through the driving control logic (e.g., 220) of the vehicle. The driving control logic 220 may also consider the present state of the vehicle as determined using a vehicle state estimation engine 660. The vehicle state estimation engine 660 may determine the present state of the vehicle (e.g., in which direction(s) it is currently moving, the speed is traveling, whether it is accelerating or decelerating (e.g., braking), etc.), which may be considered in determining what driving functions of the vehicle to actuate and how to do so (e.g., using driving control logic 220). For instance, some of the sensors (e.g., 605, 610, 615, etc.) may be provided as inputs to the vehicle state estimation engine 660 and state information may be generated and provided to the driving control logic 220, which may be considered, together with motion planning data (e.g., from motion planning engine 655) to direct the various actuators of the vehicle to implement the desired path of travel accurately, safely, and comfortably (e.g., by engaging steering controls (e.g., 665), throttle (e.g., 670), braking (e.g., 675), vehicle body controls (e.g., 680), etc.), among other examples.

To assess the performance of the automated driving system and its collective components, in some implementations, one or more system management tools (e.g., 685) may also be provided. For instance, system management tools 685 may include logic to detect and log events and various data collected and/or generated by the automated driving system, for instance, to detect trends, enhance or train machine learning models used by the automated driving system, and identify and remedy potential safety issues or errors, among other examples. Indeed, in some implementations, system management tools 685 may include safety sub-systems or companion tools, and may further include fault detection and remediation tools, among other example tools and related functionality. In some implementations, logic utilized to implement the automated driving system (e.g., perception engine 238, localization engine 240, vehicle state estimation engine 660, sensor fusion logic, machine learning inference engines and machine learning models, etc.) may be utilized to support or at least partially implement an observation engine at the vehicle, which may make use of sensor data to determine observed characteristics of an identified event and generate corresponding observation data to be loaded in records of a distributed database, among other example uses.

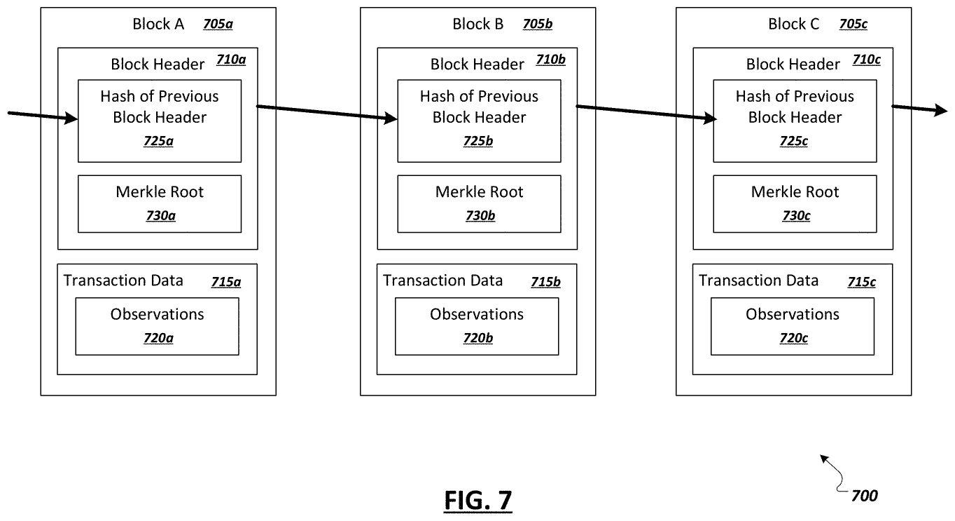

Turning to FIG. 7, a simplified block diagram is shown illustrating a representation of an example blockchain distributed data structure 700. The distributed data structure may be made up of a “chain” of linked block structures (e.g., 705a-c). Each block may include a respective block header (e.g., 710a-c), which includes a hash (e.g., 725a-c) of the preceding block's header to serve as a link to the preceding block in the chain. A block header (e.g., 710a-c) may include a variety of other data or fields, based on the particular implementation of the data structure, including fields indicating the time of the block's creation, a nonce value used for the hash, and a Merkle root value (e.g., 730a-c), among other examples. Each block (e.g., 705a-c) additionally includes respective transaction data 715a-c. In some implementations, the blockchain-based distributed data structure 700 may be dedicated to storing observations generated by computing systems implement autonomous driving environments and collected (e.g., within a given geographic domain or worldwide) in response to safety events. In other implementations, the distributed data structure 700 may be mixed-use, with observations involving driving safety events included as transactions within blocks (e.g., 705a-c) together with other transactions. In such examples, other transactions may include and describe non-safety related events, or may include observations of other non-driving related safety events. In some cases, transaction data 715a-c may include one a single observation or transaction. In other instances, multiple transactions, even multiple different observations (e.g., involving multiple different events) may be stored in a single block. A Merkle root value (e.g., 730a-c) may be generated based on the combined content of the transactions/observations included in the transaction data 715a-c. Observation data (e.g., 720a-c) stored within a block (e.g., 705a-c) may include information in addition to the observations generated from sensor data at a road actor system, such as an identifier associated with the event described in the observation, time and/or location information corresponding to the observation, identification of the system and system components utilized in generation of the observation (e.g., model number, version number, serial number, etc.), among other example information. Additionally, observation data, in some instances, may include not only the determined observation but also a copy of the raw sensor data (and sub-decisions, inferences, etc.) generated at the road actor and utilized to generate the observation(s), among other examples.

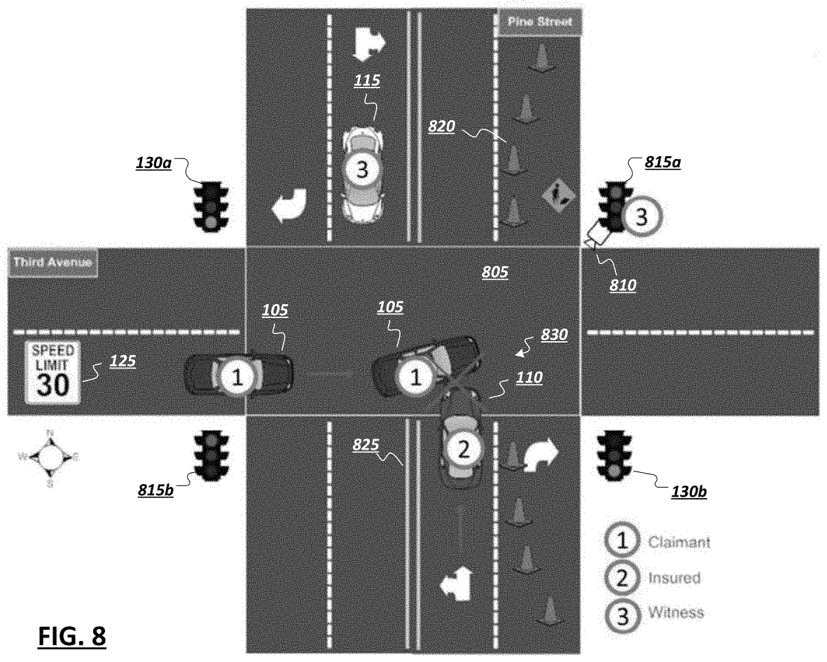

Turning to FIG. 8, an example driving safety event is illustrated, which may be monitored and observed by the computing systems and sensors of various agents. Generally, when an accident occurs, several different agents may be present, including one or more active vehicles (e.g., 105, 110) as well as passive agents (witnesses), which could be either other vehicles (e.g., 115), infrastructure elements (e.g., roadside-mounted cameras or other sensors (e.g., 810)), or by-standers (e.g., with data collected by a personal computing device carrier or worn by the by-stander), among other examples. Given multiple different agent, the circumstances that lead to a particular event (e.g., accident 830) can be analyzed from multiple points of view.

In the example of FIG. 8, vehicles 1 (105) and 2 (110) are involved in a collision at an intersection 805. At least one other vehicle (vehicle 3 (115)) is present at the intersection 805 and sensors of the vehicle 115 “witness” the accident by recording conditions at or near the vehicle leading up to and during the collision. Additional, witness systems may also be present, implemented as either additional vehicles or road-side sensors. For instance, in the example of FIG. 8, a camera 810 mounted on a traffic signal (e.g., 815a) may also observe conditions and vehicle behaviors at the intersection 805. In this example (which will be relied on as a non-limiting example to provide context for subsequent figures and discussion), at time t-2, vehicle 1 is traveling toward the intersection 805, at time t-1, the collision occurs, and at time t sensor data is coalesced by each of the witness systems (e.g., 105, 110, 115, 810) and one observations may be generated and shared with other systems (e.g., for inclusion in distributed database record). Each of the observing agent systems (e.g., 105, 110, 115, 810), may be equipped with logic to detect vehicles and their behavior, road hazards (e.g., 820), road lane markings (e.g., 825), traffic signs and signals (e.g., 125, 130a-b, 815a-b), among other conditions (e.g., human or animal actors, weather conditions, road conditions, etc.) and determine proper operating behaviors from these conditions (e.g., based on a standardized safety model). Each observing system may generate one or multiple observations describing the accident using this logic, the observations describing compliance with one or more driving safety standards by one or more of the vehicles (e.g., 105, 110, 115) at the scene.

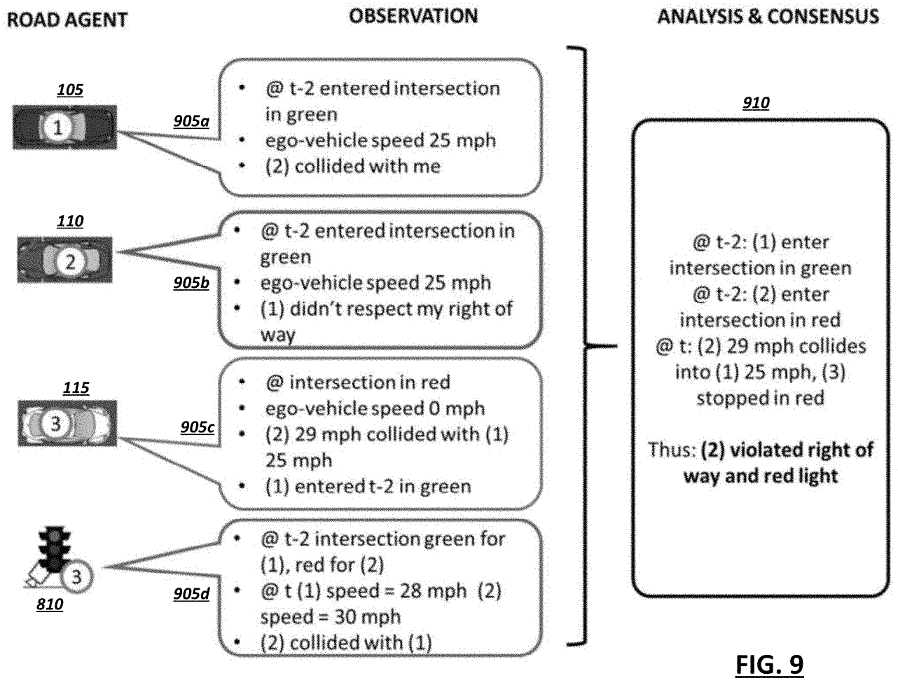

As illustrated by FIG. 9, the observations (e.g., 905a-d) generated by the respective agent systems (e.g., 105, 110, 115, 810) may represent multiple points of view of a road safety event. Indeed, the analysis from the point of view of each agent can be considered each agent's respective “testimony” concerning the event for use at a later stage in establishing roles and responsibilities within an insurance claim or legal process. Indeed, the observations may be provided as inputs to a post-processing of the observations of all agents identified as witnesses of the event in order to achieve a consensus of what happened.

In the example of FIG. 9, the accident of FIG. 8 is described by the specific observations 905a-d of each of the agent systems (e.g., 105, 110, 115, 810). For instance, the system of vehicle 1 may determine, from its local sensor data, that it entered the intersection 805 while its traffic light (e.g., 130a) was green (at time t-2), and further determine that it was traveling through the intersection at 25 mph (in a 30 mph zone), when vehicle 2 (110) collided with vehicle 1 (105) in the intersection 805. Vehicle 2 (110) may process its local sensor data using autonomous driving logic to reach its own observations, such as that the vehicle 110 entered the intersection 805 while its traffic light (e.g., 815a) was green at a speed of 25 mph. Vehicle 2 (110) may further determine that, based on identification of vehicle 1 and the location and speed of vehicle 1, that vehicle 1 did not respect the expected right of way at or immediately before the accident, among other example observations. While the observations 905a,b may be contradictory, additional observations may be available, which can lead to a consensus observation of the event. For instance, observation 905c of a third vehicle 115 may be generated by the vehicle's 115 system based on its local sensor data to determine that it was stationary at the intersection (based on recognition that its traffic light was red), that vehicle 2 traveled at a speed of 29 mph when it collided with vehicle 1 (traveling at 25 mph), and that vehicle 1 entered the intersection 805 while its light 130a was green. Further, a roadside sensor system (e.g., 810) may process its data to determine that at time t-2, traffic lights (e.g., 130a-b, 815a-b) signaled green for vehicle 1 (105) and red for vehicle 2 (110), that at the time of the accident (t-1), vehicle 1's speed was 29 mph and vehicle 2's speed was 30 mph, and that the collision occurred between vehicles 1 and 2. Each of these observations (e.g., 905a-d) represent more than raw sensor data, but are the product of potentially multiple rounds of processing of potentially multiple types of sensor data in order to reach the observation (e.g., sensor fusion, object detection/recognition, movement sensing, path planning, etc.). From these multiple observations, a consensus analysis (e.g., 910) may be performed—in this example, identifying that vehicle 2 (110) violated right of way and red-light standards/rules and should be held as the cause of the accident.

Collecting observations by road agent systems may be particularly critical in partial or fully automated driving conditions where responsibilities might be established, not by human observations and testimonies, but by automated vehicles or intelligent infrastructure sensors. In some implementations, constraints or assumptions may be adopted in the systems generating such observations, such that information is trusted and secure (e.g., to trust that a given agent's observations are true according to its perception and observational capabilities and not the result of an impersonation or even physical attack that altered his perception or observational capabilities). In some implementations, censorship of system observations may be limited or prohibited, allowing potentially every agent (determined to be) present in the accident with a particular point of view to contribute their testimony on the accident in a way that it is public, not censored, and not tampered with once contributed to public knowledge. Determining the universe of agents for which observations may be generated and considered can be determined, for instance, by geo and time fencing the road event (e.g., implementing a rule that in order to submit an observation, the agent needs to be present in the location and at the time of the event). Additionally, observations may be defined to specifically identify the contributing agent, enabling trust in that agent to be assessed as well as to identify how to audit or further process the logic and sensor data underlying a given agent's observation(s). In some implementations, such trust and security may be implemented, at least in part, using a combination of trusted execution environments and blockchain technology, among other example features.

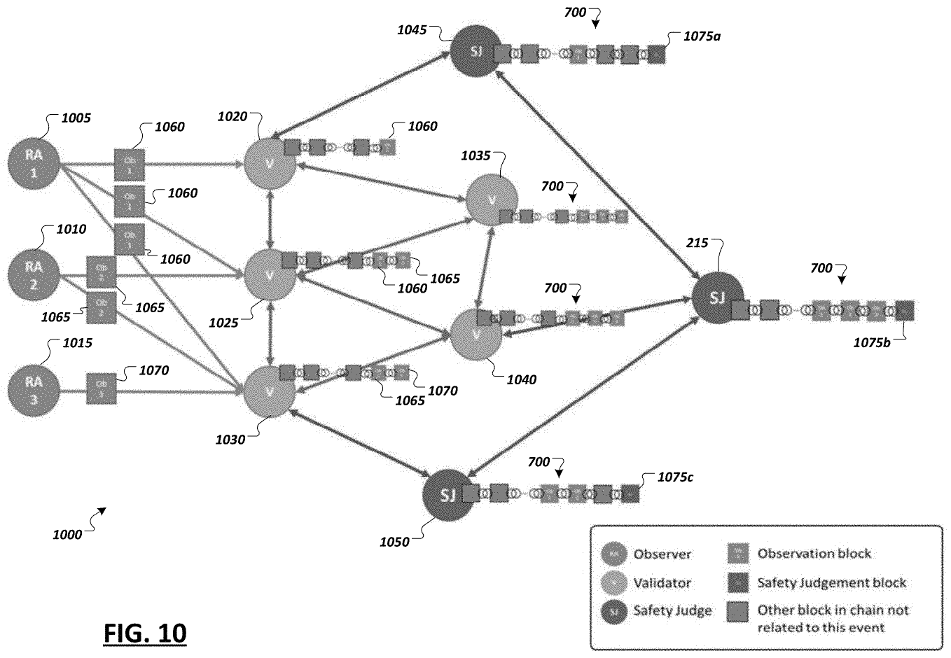

In light of the above, a system may enable every involved road agent to contribute valuable observations of a road event considering that, in an incoming future, there might be no human involved in the observations and thus automated systems must make those observations. Further, a consensus determination concerning the causes and circumstances surrounding an event may be based on a consolidated safety judgment from all those observations and stored as trusted, legal evidence for use in further action (e.g., civil or criminal litigation, insurance claims, feedback to providers of autonomous vehicles, etc.). Turning to FIG. 10, a representation 1000 of an example traffic safety blockchain data structure 700 is illustrated for use in connection with an observation-based consensus system. A traffic safety blockchain data structure may be implemented as a distributed platform to store observations of traffic safety violations performed by authenticated road agents and validated by other blockchain-nodes. Additionally, a traffic safety blockchain data structure can store judgments which are determined from the collected observations, representing a consensus summary of all the observations pertaining an event.

Various functional roles may be defined within a system implementing and contributing to an example traffic safety blockchain data structure 700, as illustrated in the example of FIG. 10. For instance, observers (e.g., 1005, 1010, 1015), such as road agents, perform observations that are validated by validator nodes (e.g., 1020, 1025, 1030, 1035, 1040). Safety judge nodes (e.g., 215, 1045, 1050) perform judgments on the validated observations presented in the traffic safety blockchain. A single system or multiple different systems may be utilized to perform all of the roles for the traffic safety blockchain 700. In some instances, higher security or authorization may be required to enable a system to perform some of the functions within the traffic safety blockchain, as the observations and judgments based on these observations may have legally binding consequences within the governing body where a particular traffic violation took place.

In one example implementation, the functional roles in a traffic safety blockchain may include Observer, Validator, and Safety Judge. These functions may be defined in separate software functions that can be executed in separate systems or within a single system (e.g., hardware element). In one example, functional requirements may be defined for an Observer such that the system owner is registered as legal entity within a governing body associated with the traffic safety blockchain (e.g., through registration of a vehicle owner through a valid drivers' license or vehicle registration, registration of roadside monitors (e.g., intelligent intersections) through a traffic management authority to confirm that the monitor(s) run valid software and are signed with a valid private key, registration of an autonomous vehicle with the traffic management authority confirming that it is running valid standard-compliant software and that its observations are signed with a valid private key, registration of a processing node with the traffic management authority confirming that it is running valid software and its activities are signed with a valid private key, etc.). Further, qualification as a valid observer may be predicated on proof (e.g., collected data showing) that the Observer was present on the location boundary where the traffic safety event is reported within a time window associated with occurrence of the traffic safety event. A Validator may be tasked with performing compliance checks on incoming blocks for the traffic safety blockchain. These blocks can include observations and/or safety judgments. The validator must evaluate that the block is legitimate as a prerequisite to the block's (or observation's) inclusion in the traffic safety blockchain. Such validation includes determination of the observer's and safety judge registration, checks on minimal requirements on the observations and safety judgments, among other example assessments. Failures on the checks may result in the rejection of the block, which may be reported back to the block's source to allow for error correction or remedying of data corruption errors during transmissions. A Safety Judge may be tasked with performing a safety judgment representing consensus of a traffic event taking into consideration all the observations that made it into the traffic safety blockchain. The entities able to perform these judgments could be restricted in the same way that observers have been described above. For example, a Safety Judge node may be required to be registered with the governing body authorities using the traffic safety blockchain, perform judgment for an event based on all observations of the same traffic safety incident (e.g., as defined by location and time bounds), unequivocally identify all active and passive agents involved in the traffic safety incident, and perform safety analysis according to the rules and standards of the corresponding governing body authority, among other example regulations.

Continuing with the example of FIG. 10, road agents (e.g., 1005, 1010, 1015), in one example, may generate proposed blocks to correspond to their respective observations and may broadcast the proposed blocks (e.g., 1060, 1065, 1070) to various validation nodes (e.g., 1020, 1025, 1030) to validate the blocks are initiate addition of the blocks to a blockchain-based distributed data structure (e.g., 700). As noted herein, in some implementations, validation may be performed at the road agent systems themselves. A fork selection or other algorithm may be defined to govern the manner in which versions of a blockchain data structure are adopted, rewarding those versions of the data structure (e.g., 1035, 1040) that have more completed work (e.g., more validated blocks), such that the copies of the blockchain data structure maintained at the various nodes eventually coalesce around a single, accepted version of the data structure (e.g., including all of the newly submitted observation blocks (e.g., 1060, 1065, 1070). The newly added blocks may be parsed, along with other blocks in the data structure by safety judge systems (e.g., 215, 1045, 1050) to detect a subset of blocks containing observations corresponding to a particular event of interest (e.g., based on the observations identifying a particular time and geography associated with the particular event). The safety judge systems (e.g., 215, 1045, 1050) may read the observations and apply a consensus algorithm, or other logic, to determine a judgment from the observations and generate a judgment block (e.g., 1075a-c) for addition to the blockchain-based distributed data structure 700. The judgment block may identify the blocks (e.g., 1060, 1065, 1070) containing the observations relied upon to generate the judgment, among other example information.

As detailed above, in some implementations, observer agents can be constrained by a set of predetermined authorship or content requirements. The enforcement of these requirements can be done in multiple forms. For example, it can be part of the client software running on the observer nodes and allowing the distribution of observations to a traffic safety blockchain structure. For instance, road agents are able to perform observations of traffic events, package them in the correct traffic safety blockchain block format, and broadcast them to other systems for verification onto the traffic safety blockchain network. The validation nodes on the traffic safety blockchain network can then carry out the checks for validity of the observation. These checks may be performed in order to prevent non-authorized agents to perform fraud on a traffic event with false observations. Similar rules may be applied to safety judge nodes to ensure their judgment blocks are similarly trusted and verified, among other example policies.

It should be appreciated that observations generated using logic of automated driving systems may be stored in potentially any secure database. Blockchain-based data stores may be particular useful, in some implementations, due to the security, data integrity, and decentralization offered through blockchain. For instance, a decentralized, distributed public database provides a mechanism for non-trusting parties to ensure the fairness of the safety observation storage. Anti-censorship may also be enabled thereby, allowing a rich source of crowdsourced observations related to safety. The storage and validation of safety traffic related observations may thus be guarded in a distributed fashion by multiple entities including but not limited to: government entities such as federal and state departments of transportation, National Highway Traffic Safety Administration (NHTSA), departments of motor vehicles, police department, court systems, etc.; non-government parties, such as insurance agencies, customer protection organization, public safety organizations, etc.; and individual citizens that could be rewarded from their work validating that the observations included in the block-chain are legitimate, among other examples. Further, once observations are stored in the blockchain, cryptographic elements may guarantee no censorship of these observations. This is accomplished via public verifiability. In the distributed ledger of a blockchain-based data structure, each state transition is confirmed by verifiers, but observers can nonetheless check that the state of the ledger has changed according to the protocol (a new observation has been made). This enables integrity by guaranteeing that the information is protected from unauthorized modifications. Consensus operations on safety judgments can then take place based on the complete observations stored in the traffic safety blockchain structure and the result of these observations with pointers to the actual data used in the calculation and metadata associated with the judgment criteria can then be appended into the blockchain as proof for claims or legal action, among other example uses. Such features may expedite and automate otherwise cumbersome processes of data recall, analysis, and litigation, among other example benefits.

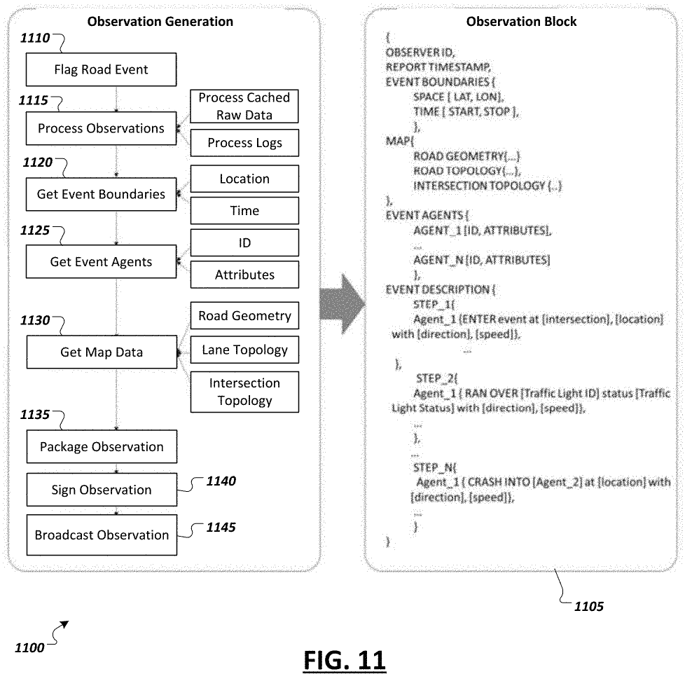

Turning to FIG. 11, a simplified block diagram 1100 is provided to illustrate the example generation of an observation block 1105 by a road agent system for inclusion in an example traffic safety blockchain structure. For instance, an alert may be indicated to flag 1110 or identify a road safety event. The road safety event may be detected and broadcast by a vehicle involved in the event, a roadside agent monitoring a roadway, by public safety officials, first responders, or other systems to identify that an accident occurred or that an infraction has been detected. Event boundaries may be defined to correspond to the identified event (e.g., based on data collected by systems on vehicles involved in the event. Agent systems receiving the broadcast event may cache raw sensor data, logs, and other data collected or generated while the agent system was present within the event boundaries. This data may be set aside and processed 1115 by the system agent to determine one or more observations corresponding to the event. The system agent may specify time and location boundaries (at 1120) to be associated with the observations from the road agent are parsed to establish event boundaries (location and time). Agent systems may be assigned a unique ID and may include (at 1125) the ID in the observation data (or other information to identify the agent system). Map data utilized or available to the agent to describe the scene of the event may also be generated or accessed (at 1130) and included in the observation data, such as road geometry, lane topology, intersection topology, and other information. The observation information may be packaged (at 1135) into a predefined observation block format and signed (at 1140) by the agent (e.g., using a private key, a unique ID and signature, or other technique) to identify and certify the road agent generating the observation block. The block may then be transmitted (at 1145) to one or more other systems for validation and inclusion in a traffic safety blockchain structure.

In some implementations, a format or fields of observations for entry in a distributed database structure may be defined to identify particular information to be included in an observation. For instance, as illustrated in the example observation 1105 shown in FIG. 11, the observation may identify time and location boundary information, identify the event actors described in the observation (which may be identified through a pseudonym due to an agent being unable to specifically identify the other vehicles and/or to preserve privacy of the actors, etc.), and identify the agent responsible for generation for the observation. Further, the observation may include a standardized description of the map data pertaining to the location where the event took place. Implementations of this part of the message can support standard structures such as the one described in SAE J2735 Dedicated Short Range Communications (DSRC) Message or SAE J2945/10 recommended practices for Signal Phase in Time and Map Data (SPAT/MAP) messages, among other example standards. The observation may then identify the circumstances and actions determined by the agent system using sensor data generated at the agent.

In some implementations, the actions and circumstances of an event described in an observation may be embodied through a sequential event description derived from measurements from the various sensors an actor is endowed with (e.g., accelerometers, cameras, LIDAR, radar sensors, proximity sensors, etc.). This description identifies an actor at a particular location in the described map performing a particular action determined using the machine learning and computer vision faculties of the agent system. The event description can contain as many entries as observational changes are necessary to describe the complete event (only limited by the quality and amount of sensor data available to the agent system pertaining to the event). These observational changes can be actions of agents which include longitudinal, lateral changes, or environmental changes or states (e.g., changes in traffic lights or infractions in signaled commands, among other examples). The time and location boundaries can be used to uniquely identify a specific traffic event. In some cases, actors may report different times and locations even though they are associated to the same event (e.g., rounding effects or because of the fact they reflect different perspectives of the event). In such cases, observances of the same event may nonetheless still be matched, for instance, by probabilistically determining commonality based on overlap in location and time within a tolerable margin. In cases where a standardized safety model is utilized in generating and articulating an autonomously generated observation, state logs of formal safety analysis as they pertain to safe lateral and longitudinal distances, time-to-collision, allowed maneuvers and behavior on intersections, such as the one defined in Responsibility Sensitive Safety definitions can be included as observations. Calculations included within the model may be leveraged to determine vehicles' infringement of rules defined in the model (e.g., RSS), among other example enhancements.

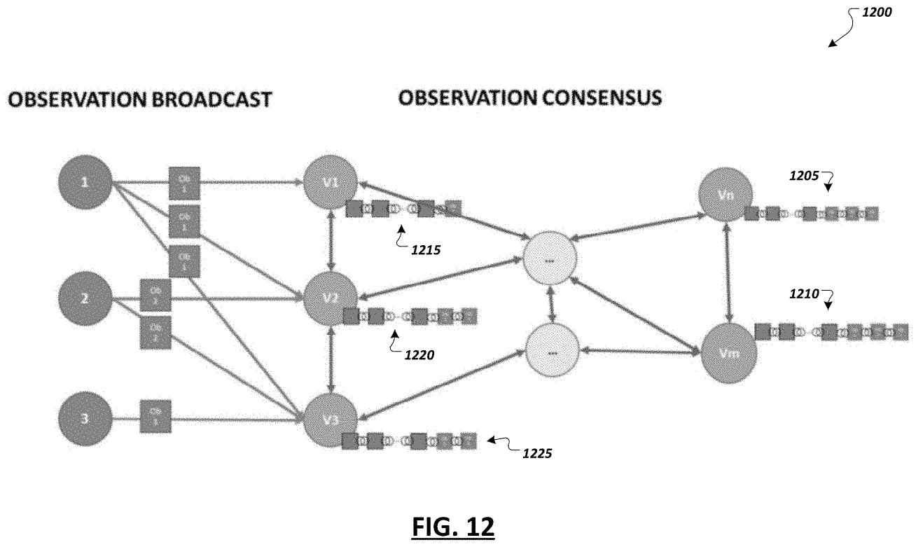

Turning to FIG. 12, a block diagram 1200 is shown illustrating the evolution of a traffic safety blockchain containing observations of a particular safety event. Initially, a block creator (e.g., a road agent) may broadcast its block (or observation data) to only a subset of the computing systems in the network maintaining the traffic safety blockchain structure. Indeed, different computing systems in the network may receive the various observations of the potentially multiple agents involved in and/or witnessing the event. Accordingly, as illustrated in FIG. 12, initially the traffic safety blockchain structure at each system in the network might not contain all the observations from a traffic event. As in traditional blockchain implementations, versions of the blockchain (e.g., 1205, 1210) that contain more valid events are awarded, or weighted more heavily, causing adoption of those versions of the blockchain having the most complete list of observations and events uploaded (over less complete versions (e.g., 1215, 1220, 1225)). Indeed, through peer-to-peer updating, the blockchain maintained at each network system will eventually be the version of the blockchain that contains all of the observation blocks generated by potentially multiple agents observing the event. Once an observation is uploaded and accepted into the traffic safety blockchain structure, it is protected against modifications through the sensitive hashing algorithm that ensures that each block is linked to the previous one.

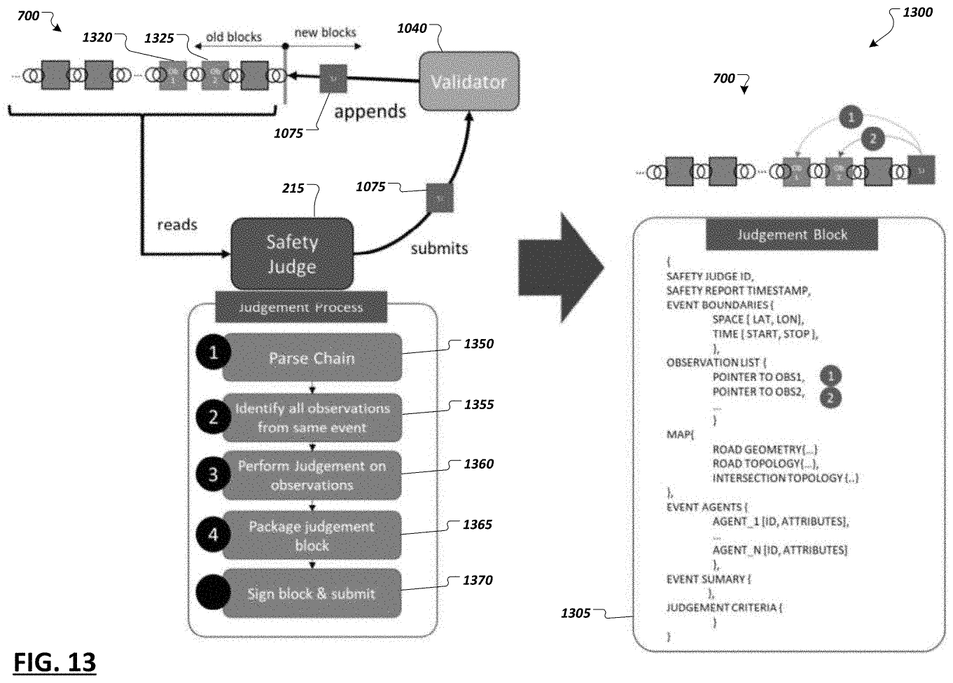

Turning to FIG. 13, a simplified block diagram 1300 is shown illustrating an example process of submitting a judgment to the traffic safety blockchain structure 700. Indeed, judgments (or judgment blocks) may be added to the traffic safety blockchain structure 700 in a manner similar to the submitting of observations to the traffic safety blockchain structure 700. In some implementations, a judgment may be determined by one or more safety judge entities (e.g., 215). The judgment may be described in a judgment block (e.g., 1075) that is generated by the safety judge system 215 and submitted to a validator node system (e.g., 1040). The proposed judgment block (e.g., 1075) may be added to the traffic safety blockchain structure upon validation of the block by the validator node system 1040. In one example, judgment blocks may include pointers to all the observation blocks (e.g., 1320, 1325) referenced in the blockchain that pertain to the same road event and upon which the judgment was based.

In one example, illustrated in FIG. 13, a safety judge system may parse 1350 observation blocks 1320, 1325 (e.g., blocks containing one or more road-agent-generated observations) stored in a traffic safety blockchain structure 700 to identify 1355 a collection of observation blocks describing a common event. In some instances, identifying the subset of observation blocks that correspond to a particular event may be performed by identifying a window of time and/or geographic window corresponding to the event and identifying those observation blocks containing observation data that include time and/or location information for observations indicating that these observations were likely generated in connection with the event. In still other examples, observation blocks may be tagged with a unique common event identifier and a safety judge system may identify observations of a common event based on inclusion of this identifier in corresponding observation blocks. In one example, agents witnessing an event may communicate with other agent systems (on a peer-to-peer basis) and negotiate an identifier for the event that each of the agents may include in respective observation data. In another example, a validator node may identify observation blocks pertaining to a common event (e.g., based on time and/or location information) and tag the validated observation blocks with an identifier, among other example implementations.

The safety judge system 215 may be used to perform judgments 1360 on the collection of observations. In some implementations, this may involve a human user assessing the content of the observations to make or assist in the judgment. In other implementations, the safety judge system 215 itself may autonomously determine a judgment based on a set of observation inputs. For instance, a defined set of judgment rules may be programmatically applied (e.g., based on a defined safety model (e.g., RSS)) to parse the information in the observation data and determine a judgment based on these rules. In some implementations, machine learning or computer-executed heuristic models may be employed by the safety judge system 215 to autonomously determine from the observation data, without the guidance of a human user, a consensus observation (e.g., based on detecting corroborating descriptions in the observations), among other example implementations. Upon determining a judgment based on a collection of observation data from a traffic safety blockchain structure, a safety judge system may generate judgment data describing the judgment and package 1365 the judgment data in a block of the traffic safety blockchain structure (e.g., a judgment block). The safety judge system 215 may then sign the block and/or judgment data, and submit (at 1370) the block for validation by a validator node 1040. Once validated, the block (e.g., 1075) is appended to the traffic safety blockchain structure.

FIG. 13 includes a representation 1305 of example judgment data for inclusion in a judgment block. As with observation data, judgment data may be generated according to a defined format to include certain standardized information related to the event and corresponding judgment determined using a safety judge system 215. For instance, the content of the judgment block 1075 may contain the safety judge identifier, the boundaries of the road event (location and time), a detailed consolidated map extracted from the observations in a standardized format, the list of all observations (e.g., by observation or block identifier), the list of all agents involved in the event, a chronological event summary, as well as the judgment criteria applied to the judgment, among other example information.

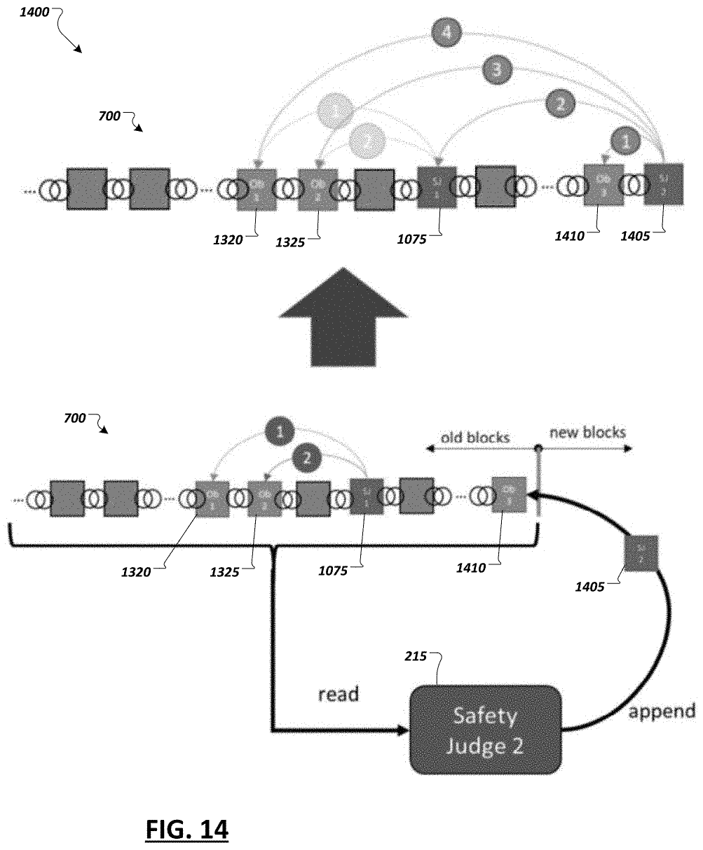

Turning to FIG. 14, a simplified block diagram 1400 is shown illustrating a supplemental judgment (e.g., 1405), which may be added based on the discovery of additional observations (e.g., 1410) for an event, which may not have been considered in a previous safety judgment block (e.g., 1075). In some implementations, a judgment block (e.g., 1075) contains pointers to all the observations (e.g., 1320, 1325) existing in the traffic safety blockchain structure (e.g., 700) and upon which the judgment is based. However, given the distributed nature of the traffic safety blockchain structure and road agents contributing blocks to the traffic safety blockchain structure, at a particular time only partial observations might be available within the traffic safety blockchain structure. This means that the first judgment (described in a first judgment block 1075 for the event) was completed based on a non-complete set of observations (e.g., 1320, 1325). In this case when a new observation is reported and appended to the traffic safety blockchain structure (e.g., as observation block 1410), this new observation is appropriately not linked to the existing judgment (described in judgment block 1315). Accordingly, new judgment can be initiated by a safety judge system in response to the addition of a new observation for the event. The safety judge system may identify the other related observations (e.g., 1320, 1325) added to the traffic safety blockchain structure 700 (e.g., by consulting judgment block 1075) and conduct a new judgment process based on the completed (or updated) set of observation blocks (e.g., 1320, 1325, 1410). A new judgment block (e.g., 1405) is then generated to memorialize the revised judgment and appended to the traffic safety blockchain structure. The revised judgment block 1405, in some implementations, may not only link to the observation blocks (e.g., 1320, 1325, 1410) relied on in the revised judgment, but can also link to the previous judgment block 1315, among other examples.

Safety judgment revisions can result, not only from additional observations, but also from revisions of safety or standardized rules used in either the underlying observation or the safety judgment. For instance, a standardized safety model may be utilized and serve as a foundation of either or both the road agent observation logic and safety judge system judgment logic. Accordingly, should updates or revisions be made to the underlying safety model, corresponding logic may also be updated. For instance, a consensus observation system may originally be based on version 1.0 of safety model (e.g., RSS), but at a later date it may be mandatory to utilize a revised version (e.g., version 1.1). Further, prior observations and judgments may no longer be considered in compliance with the newly revised standard. As such, in some implementations, an update to underlying safety standards may trigger updated observations and/or updated judgments to be calculated by their respective systems (e.g., road agent systems and/or safety judge systems (e.g., 215)) and corresponding replacement observation blocks and judgment blocks may be appended to the traffic safety blockchain structure. Such updated blocks may include information to identify that they represent a revision of previous versions of the consensus observation and may link to the previous observation blocks and judgment blocks to memorialize the relationship and the revision, among other example features.

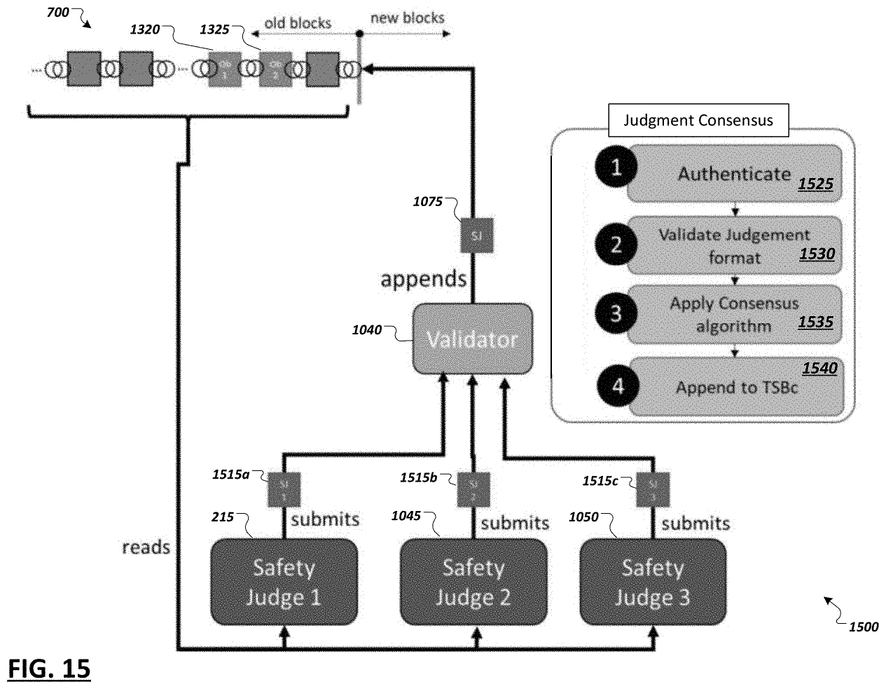

In some implementations, the process that leads to a safety judgment decision about an event based on observations stored on the traffic safety blockchain structure may also be distributed. For instance, multiple judge systems can be provided and utilized to reach a consensus judgment, rather than instilling all trust in a single judge system. Indeed, multiple safety judges can be involved in this process to guarantee fault tolerance and dependability (e.g., enabling the system to be able to tolerate the failure or unavailability of one or more safety judges) and fairness (e.g., to diversify the judgment decision-makers such that all trust is not endowed in a single safety judge). FIG. 15 is a simplified block diagram 1500 illustrating an implementation involving multiple safety judge systems (e.g., 215, 1045, 1050) operating together using a common set of observations for an event (e.g., described in observation blocks 1320, 1325 of traffic safety blockchain structure 700) to reach a consensus judgment for the event. Accordingly, each of the safety judge systems may apply respective judgment logic (or, alternatively be driven by or supplemented by judgment of a respective human operator) to reach a respective decision (e.g., 1515a-c) based on the common set of observations (e.g., 1320, 1325). A validator node system (e.g., 1040), or alternatively an additional safety judge system, can be provided to collect the respective judgments and apply a standardized consensus algorithm to determine a consensus judgment from the multiple judgment inputs (e.g., 1515a-c). For instance, the validator node 1040 may perform this consensus judgment by first authenticating (e.g., 1525) each of the participating safety judge systems (e.g., 215, 1045, 1050) and their inputs 1515a-c by validating 1530 their respective formats. The consensus algorithm may be applied 1535 to the inputs by the validator node system 1040 to derive the consensus judgment. The consensus judgment may then be packaged as a judgment block 1075 to be appended 1540 to the traffic safety blockchain structure 700.

In some implementations, where multiple different safety rules, standards, and corresponding models co-exist, multiple participating safety judge systems may be used to allow each of these co-existing rules to be applied in a consensus judgment. In some implementations, each of the multiple safety judge systems (e.g., 1305, 1505, 1510) may package and load their respective judgments as judgment blocks appended to the traffic safety blockchain structure 700. As a post process, where multiple different judgment blocks (from multiple safety judge systems) are identified as having been appended to the traffic safety blockchain structure 700, a validator node or additional safety judge system may extract the judgments from each of the blocks and perform the consensus algorithm to derive a consensus judgment based on these individual judgments (e.g., 1515a-c). A new judgment block may then be appended to the traffic safety blockchain structure 700 that memorializes the determined consensus judgment and that links to the individual judgments (e.g., 1515a-c) upon which the consensus judgment is based.

A consensus algorithm utilized to derive a consensus judgment, such as introduced above, may be based on or utilize any suitable consensus algorithm to represent corroborations between the judgments, a majority or plurality consensus, etc. As an example, assuming there are N safety judges that submit decisions d1, d2, . . . , dN, a validator can compute the final decision as D=F(d1, d2, . . . , dN) where the function F computes the histogram of the input decision values and returns the decision value that has the highest count. In case a majority cannot be established the validator can store a warning transaction indicating that a final decision could not be made, among other example implementations.

One risk facing autonomous observation and judgment operations is the possible integrity issues introduced when trusted operation is compromised at one of the agents (e.g., a road agent, validator node, safety judge system, etc.). As one example, a compromised or malicious agent may “lie”, such as where a road agent maliciously (or erroneously) generate an observation report with false information of a road event. In some implementations, in order to be validated as a trusted agent, an agent system may be required to include secured hardware and secured communication functionality, for instance, through a combination of a Trusted Execution Environment (TEE) implement with trusted I/O blocks on each road agent. Such security can guarantee that unless an agent is tampering with the actual physical sensors (e.g., in a physical attack) the observations recorded by the agents can be trusted and validated, among other example solutions and implementations.

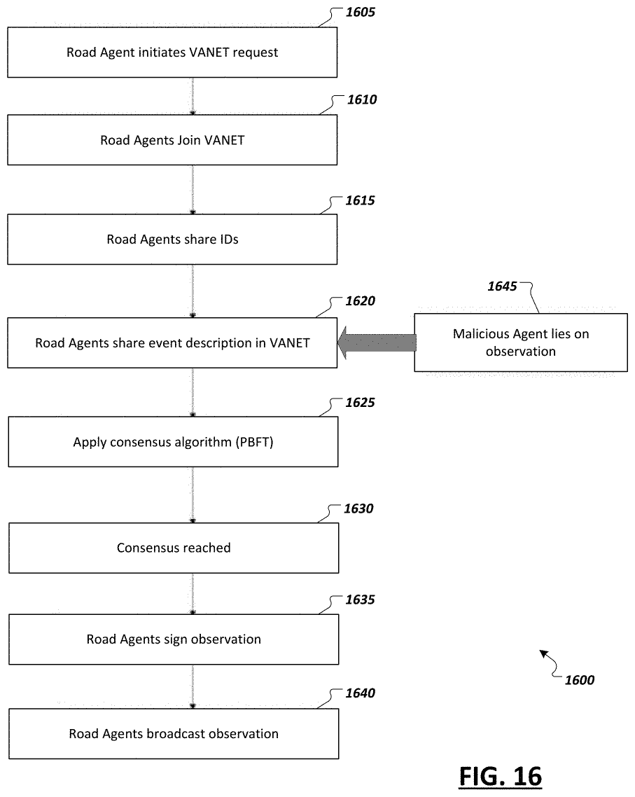

While the possibility exists for an individual observation or judgment contribution to be in error or compromised, consensus-based determinations utilizing multiple observation and judgment inputs may allow the problem of a malicious agent to be mitigated by making decisions about an accident based on a majority of observation reports and/or judgments that are in agreement with one another. The system assumes that a majority of authenticated agents reporting observation reports about an accident will be trustworthy and accurate. FIG. 16 is a simplified flow diagram 1600 illustrating an example flow in a distributed road safety consensus to illustrate this principle. In this example, one or more road agents (e.g., a roadside sensor device, computer-equipped vehicles (e.g., including autonomous and non-autonomous vehicles), a drone, etc.) may initiate a vehicle ad hoc network (VANET) through a request (at 1605). Accordingly, a set of road agents in ranges of the request may join the VANET (at 1610) and share agent identification information (at 1615), such as an identifier or name, sensor capabilities, manufacturer and/or model information, agent type identifier, location information, among other example information.

In some instances, in response to a safety event, the road agents may share, broadcast, or otherwise generate and send respective observation data (at 1620) to describe conclusions reached by the respective road agent (from sensor data at the agent) regarding particular safety attributes of one or more vehicles' motion/behavior within or leading up to the event. As noted above, in some cases, this may involve storing and sharing the observation through a distributed linked list data structure, such as a blockchain data structure. A consensus algorithm (e.g., a Practical Byzantine Fault Tolerance (PBFT) algorithm) may be applied (at 1625) to the set of observations generated by the set of road agents witnessing or participating in the event to reach a consensus judgment (at 1630) concerning the attributes and potential cause of the event. As such, incentives may exist for an observer system (agent), or malicious user in control (rightfully or wrongfully) of the system, to generate false or exaggerated observations that paint the vehicle or entity associated with the agent in a favorable light, within the context of a particular safety event. Accordingly, situations may arise where a dishonest or inaccurate observation is submitted (e.g., at 1645) for consideration among rightful observations in a consensus determination 1625. However, in cases where multiple observations are provided (in some cases by parties with competing interests), it may be assumed that an untruthful or faulty (e.g., generated through a malfunction of the logic utilized to derive the observation) may be afforded little weight, or disregarded entirely, based on the nature of the consensus algorithm applied and the competing observations provided as inputs to the algorithm (which, likely, would at least partially corroborate each other if they are generated by trustworthy systems witnessing the same event).

In some implementations, such as illustrated in the example of FIG. 16, agent systems may derive a pre-judgment consensus or even replace the role of the safety judge system by determining, in a peer-to-peer manner, a single combined consensus observation for an event. For instance, a collection of road agent systems may be configured with logic to perform a consensus algorithm based on the individual observations of the road agents reporting details observed by road agent sensors at the scene of an event. Accordingly, while interconnected in a VNET, one or more of the agents may be tasked with collecting the individual observations generated by the agents and perform a consensus algorithm (at 1625) to derive a consensus observation (at 1630) for the group of agents. The agents may then sign 1635 the consensus algorithm (although malicious agents may refrain from signing the consensus algorithm, if it discounts the malicious or erroneous observation issued by the malicious agent (e.g., at 1645), serving as evidence of the outlying nature of the observation 1645) and broadcast 1640 the signed consensus observation data to one or more external systems (e.g., for validation, verification, storing the signed consensus observation data is a corresponding observation block in a traffic safety blockchain data structure), among other examples.

In some implementations, consensus roles may be consolidated such that validation and judgment are performed during the same transaction by the same system. In other cases, such as in other examples discussed herein, validation and judgment may be carried out separately. For instance, depending on the speed at which at least an initial judgment should be reached, as well as the desired amount of data to be stored on a traffic safety blockchain structure per accident, the majority decision could be done either by validators before storing information on the traffic safety blockchain structure or later by the safety judges if it is fine to store the whole list of observations related to a particular accident on the traffic safety blockchain structure, among other examples and policies. Indeed, in some implementations, road agents may be provided with the combined logic for generating observations, validating one or more of the observations, accessing the observation blocks related to the event, and determining a judgment based on the observations. In such instances, each road agent may serve as one of multiple safety judges and provide their judgments to another trusted system to apply a consensus algorithm to the individual judgments. In such examples, agents involved in an accident may agree on the scene on a single accident report (that includes the consensus judgment of the agents) to minimize what is stored on the traffic safety blockchain structure and increase the speed at which an initial judgment is determined for an event, among other example considerations and features.

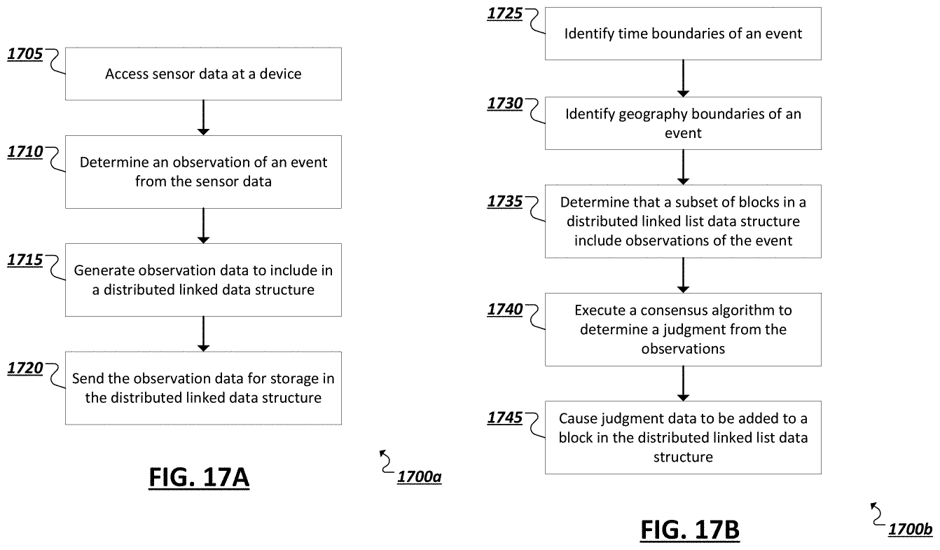

While much of the above discussion has focused on in-vehicle and roadside systems monitoring road safety events and apply vehicle safety standards to incidents involving at least partially autonomous road vehicles, it should be appreciated that the principles discussed herein may equally apply in other environments, where machines, designed to move autonomously, may be involved in safety-related events. For instance, similar solutions and systems may be derived based on the principles above for machines including aerial vehicles, watercraft, unmanned drones, industrial robots, personal robots, among other examples. For instance, FIGS. 17A-17B are simplified flow diagrams 1700a-b illustrating example techniques utilized in ascertaining attributes of safety related events involving machines configured to physically move autonomously (e.g., under control of computing systems utilizing machine learning and artificial intelligence).

For instance, as shown in FIG. 17A, sensor data may be accessed 1705 at a device, the device including a set of sensors of the same or different types. The raw sensor data may be processed, utilizing computing logic implemented at the device, including, for instance, machine learning logic to determine 1710 observations of a particular event from the raw sensor data. Such observations may identify particular actors involved in the event and describe motion of the actors within the context of particular standardized safety principles or rules (e.g., RSS standards). The observation may be described in observation data generated 1715 at the device for inclusion in a distributed linked data structure (e.g., a blockchain-based data structure). In some cases, the observation data may be included with other data (e.g., other observations from other agents or other unrelated transactions) in a single block to be added to the linked data structure. In other cases, a new block may be dedicated to containing the observation data, such that the observation would be added as a corresponding observation block in the linked data structure, among other example embodiments. The observation data may then be sent to another system to cause the observation data to be added to the distributed linked data structure (e.g., after being validated at the device or by the other system).

As shown in FIG. 17B, observations of an event may be utilized to determine, from multiple observations, a consensus observation or determination of the attributes, causes, and actors within an event involving a machine capable of autonomous motion (e.g., a robot, autonomous vehicle, etc.). For instance, a safety judge system may identify the event, a window of time (e.g., time boundaries) corresponding to the event (at 1725) and geographical boundaries for the event (at 1730) that covers the actions of the event and the likely proximate actions leading up to the event. Using the time and geographic boundaries as criteria, the safety judge system may parse a distributed linked data structure (e.g., a blockchain-based data structure) to identify a set of blocks in the data structure describing observations determined by agents involved in or witnessing the event. A consensus algorithm may be employed using the observations as inputs, to determine (at 1740) a judgment from the observations. Judgment data may be generated to describe the judgment and the judgment data may be caused 1745 to be added to a block of the distributed linked data structure.

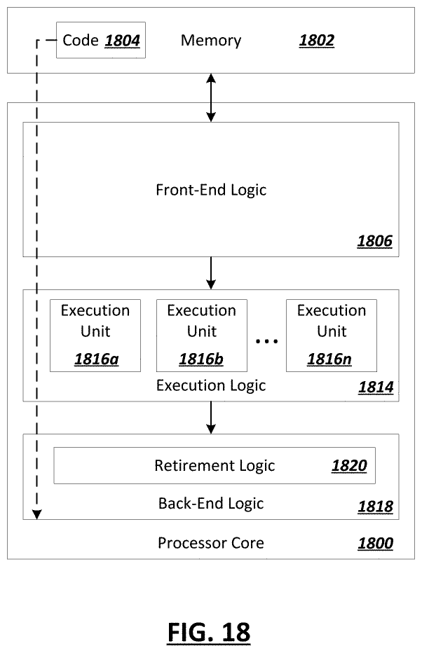

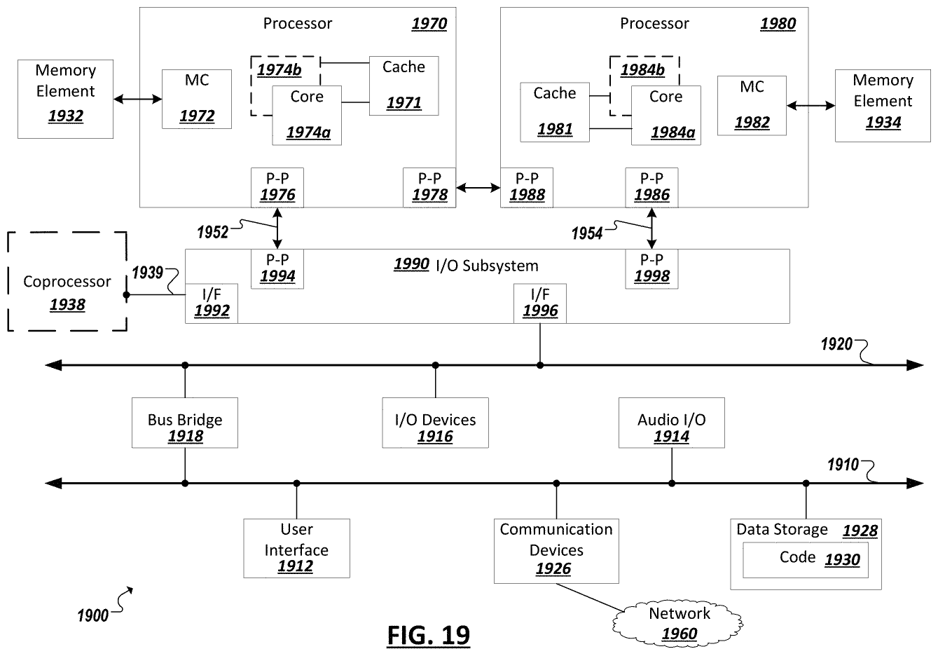

FIGS. 18-19 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 18-19.

FIG. 18 is an example illustration of a processor according to an embodiment. Processor 1800 is an example of a type of hardware device that can be used in connection with the implementations above. Processor 1800 may be any type of processor, such as a microprocessor, an embedded processor, a digital signal processor (DSP), a network processor, a multi-core processor, a single core processor, or other device to execute code. Although only one processor 1800 is illustrated in FIG. 18, a processing element may alternatively include more than one of processor 1800 illustrated in FIG. 18. Processor 1800 may be a single-threaded core or, for at least one embodiment, the processor 1800 may be multi-threaded in that it may include more than one hardware thread context (or “logical processor”) per core.

FIG. 18 also illustrates a memory 1802 coupled to processor 1800 in accordance with an embodiment. Memory 1802 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 1800 can execute any type of instructions associated with algorithms, processes, or operations detailed herein. Generally, processor 1800 can transform an element or an article (e.g., data) from one state or thing to another state or thing.

Code 1804, which may be one or more instructions to be executed by processor 1800, may be stored in memory 1802, or may be stored in software, hardware, firmware, or any suitable combination thereof, or in any other internal or external component, device, element, or object where appropriate and based on particular needs. In one example, processor 1800 can follow a program sequence of instructions indicated by code 1804. Each instruction enters a front-end logic 1806 and is processed by one or more decoders 1808. The decoder may generate, as its output, a micro operation such as a fixed width micro operation in a predefined format, or may generate other instructions, microinstructions, or control signals that reflect the original code instruction. Front-end logic 1806 also includes register renaming logic 1810 and scheduling logic 1812, which generally allocate resources and queue the operation corresponding to the instruction for execution.

Processor 1800 can also include execution logic 1814 having a set of execution units 1816a, 1816b, 1816n, etc. Some embodiments may include a number of execution units dedicated to specific functions or sets of functions. Other embodiments may include only one execution unit or one execution unit that can perform a particular function. Execution logic 1814 performs the operations specified by code instructions.

After completion of execution of the operations specified by the code instructions, back-end logic 1818 can retire the instructions of code 1804. In one embodiment, processor 1800 allows out of order execution but requires in order retirement of instructions. Retirement logic 1820 may take a variety of known forms (e.g., re-order buffers or the like). In this manner, processor 1800 is transformed during execution of code 1804, at least in terms of the output generated by the decoder, hardware registers and tables utilized by register renaming logic 1810, and any registers (not shown) modified by execution logic 1814.

Although not shown in FIG. 18, a processing element may include other elements on a chip with processor 1800. For example, a processing element may include memory control logic along with processor 1800. The processing element may include I/O control logic and/or may include I/O control logic integrated with memory control logic. The processing element may also include one or more caches. In some embodiments, non-volatile memory (such as flash memory or fuses) may also be included on the chip with processor 1800.

FIG. 19 illustrates a computing system 1900 that is arranged in a point-to-point (PtP) configuration according to an embodiment. In particular, FIG. 19 shows a system where processors, memory, and input/output devices are interconnected by a number of point-to-point interfaces. Generally, one or more of the computing systems described herein may be configured in the same or similar manner as computing system 1800.

Processors 1970 and 1980 may also each include integrated memory controller logic (MC) 1972 and 1982 to communicate with memory elements 1932 and 1934. In alternative embodiments, memory controller logic 1972 and 1982 may be discrete logic separate from processors 1970 and 1980. Memory elements 1932 and/or 1934 may store various data to be used by processors 1970 and 1980 in achieving operations and functionality outlined herein.

Processors 1970 and 1980 may be any type of processor, such as those discussed in connection with other figures herein. Processors 1970 and 1980 may exchange data via a point-to-point (PtP) interface 1950 using point-to-point interface circuits 1978 and 1988, respectively. Processors 1970 and 1980 may each exchange data with a chipset 1990 via individual point-to-point interfaces 1952 and 1954 using point-to-point interface circuits 1976, 1986, 1994, and 1998. Chipset 1990 may also exchange data with a co-processor 1938, such as a high-performance graphics circuit, machine learning accelerator, or other co-processor 1938, via an interface 1939, which could be a PtP interface circuit. In alternative embodiments, any or all of the PtP links illustrated in FIG. 19 could be implemented as a multi-drop bus rather than a PtP link.

Chipset 1990 may be in communication with a bus 1920 via an interface circuit 1996. Bus 1920 may have one or more devices that communicate over it, such as a bus bridge 1918 and I/O devices 1916. Via a bus 1910, bus bridge 1918 may be in communication with other devices such as a user interface 1912 (such as a keyboard, mouse, touchscreen, or other input devices), communication devices 1926 (such as modems, network interface devices, or other types of communication devices that may communicate through a computer network 1960), audio I/O devices 1914, and/or a data storage device 1928. Data storage device 1928 may store code 1930, which may be executed by processors 1970 and/or 1980. In alternative embodiments, any portions of the bus architectures could be implemented with one or more PtP links.

The computer system depicted in FIG. 19 is a schematic illustration of an embodiment of a computing system that may be utilized to implement various embodiments discussed herein. It will be appreciated that various components of the system depicted in FIG. 19 may be combined in a system-on-a-chip (SoC) architecture or in any other suitable configuration capable of achieving the functionality and features of examples and implementations provided herein.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. Example 1 is a machine-readable storage medium with instructions stored thereon, where the instructions are executable by a processor to cause the processor to: access sensor data generated by sensors of a device in an environment; determine, from the sensor data, an observation of an event, where the observation identifies movement of one or more machines within the environment in association with the event; generate observation data to include in a distributed linked data structure, where the observation data identifies the observation; and send the observation data to another system for storage in the distributed linked data structure.

Example 2 includes the subject matter example 1, where generation of the observation data includes performing an inference using a machine learning model based on at least a portion of the sensor data.

Example 3 includes the subject matter any one of examples 1-2, where the observation is based on a standardized safety model, and the standardized safety model defines a set of calculations to model a set of safe operating standards, and the observation is generated, at least in part, using one or more of the set of calculations.

Example 4 includes the subject matter example 3, where the standardized safety model includes a Responsibility Sensitive Safety (RSS)-based model.

Example 5 includes the subject matter any one of examples 1-4, where at least a particular one of the one or more machines is configured to move autonomously.

Example 6 includes the subject matter example 5, where the particular machine includes the device.

Example 7 includes the subject matter example 6, where the particular machine includes an autonomous vehicle.

Example 8 includes the subject matter any one of examples 6-7, where the observation is determined, at least in part, using logic utilized by the machine to make decisions in association with performance of autonomous movement.

Example 9 includes the subject matter any one of examples 1-8, where the distributed linked data structure includes a blockchain data structure and the blockchain data structure includes observation data to describe a plurality of observations for the event.

Example 10 includes the subject matter example 9, where the instructions are further executable to cause the processor to generate a new block for inclusion in the blockchain data structure, the new block includes the observation data, and each of the plurality of observations are contained in a respective one of a plurality of blocks to be included in the blockchain.

Example 11 includes the subject matter any one of examples 1-10, where the observation data includes time information corresponding to occurrence of the event and location information identifying geographic boundaries of the environment.

Example 12 includes the subject matter any one of examples 1-11, where the sensor data is generated by a plurality of different types of sensors at the device.

Example 13 includes the subject matter any one of examples 1-12, where the observation identifies each one of a plurality of machines involved in the event.

Example 14 is a method including: accessing sensor data generated by sensors of a device in an environment; determining, from the sensor data, an observation of an event, where the observation identifies movement of one or more machines within the environment in association with the event; generating observation data to include in a distributed linked data structure, where the observation data identifies the observation; and sending the observation data to another system for storage in the distributed linked data structure.

Example 15 includes the subject matter example 14, where generation of the observation data includes performing an inference using a machine learning model based on at least a portion of the sensor data.

Example 16 includes the subject matter any one of examples 14-15, where the observation is based on a standardized safety model, and the standardized safety model defines a set of calculations to model a set of safe operating standards, and the observation is generated, at least in part, using one or more of the set of calculations.

Example 17 includes the subject matter example 16, where the standardized safety model includes a Responsibility Sensitive Safety (RSS)-based model

Example 18 includes the subject matter any one of examples 14-17, where at least a particular one of the one or more machines is configured to move autonomously.

Example 19 includes the subject matter example 18, where the particular machine includes the device.

Example 20 includes the subject matter example 19, where the particular machine includes an autonomous vehicle.

Example 21 includes the subject matter any one of examples 18-19, where the observation is determined, at least in part, using logic utilized by the machine to make decisions in association with performance of autonomous movement.

Example 22 includes the subject matter any one of examples 14-21, where the distributed linked data structure includes a blockchain data structure and the blockchain data structure includes observation data to describe a plurality of observations for the event.

Example 23 includes the subject matter example 22, further including generating a new block for inclusion in the blockchain data structure, the new block includes the observation data, and each of the plurality of observations are contained in a respective one of a plurality of blocks to be included in the blockchain.

Example 24 includes the subject matter any one of examples 14-23, where the observation data includes time information corresponding to occurrence of the event and location information identifying geographic boundaries of the environment.

Example 25 includes the subject matter any one of examples 14-24, where the sensor data is generated by a plurality of different types of sensors at the device.

Example 26 includes the subject matter any one of examples 14-25, where the observation identifies each one of a plurality of machines involved in the event.

Example 27 is a system including means to perform the method of any one of examples 14-26.

Example 28 is a machine-readable storage medium with instructions stored thereon, where the instructions are executable by a processor to cause the processor to: identify time boundaries of an event, where the event corresponds to an unsafe action by an autonomous machine within an environment; identify geographic boundaries of the event associated with the environment; determine that a subset of blocks in a distributed linked data structure include a plurality of observations of the event based on the time boundaries and the geographic boundaries, where the subset of blocks include observation data describing the plurality of observations, and each of the plurality of observations is derived by a respective one of a plurality of devices from sensor data generated at the corresponding device; execute a consensus algorithm to determine a judgment from the plurality of observations; and cause judgment data to be added to a block of the distributed linked data structure to describe the judgment.

Example 29 includes the subject matter example 28, where the judgment data includes references to each one of the plurality of observations in the subset of blocks.

Example 30 includes the subject matter any one of examples 28-29, where at least one of the plurality of observations is generated by logic resident on the autonomous machine.

Example 31 includes the subject matter any one of examples 28-30, where the autonomous machine includes one of an autonomous vehicle or a robot.

Example 32 includes the subject matter any one of examples 28-31, where the instructions are further executable to cause the processor to: identify addition of another observation of the event to a particular block of the distributed linked data structure after addition of the judgment block to the distributed linked data structure; determine a revised judgment for the event based on the other observation and the plurality of observations; and cause additional judgment data to be added to another block in the distributed linked data structure to describe the revised judgment.

Example 33 includes the subject matter any one of examples 28-32, where each of the plurality of observations is contained in a respective one of the subset of blocks, and the judgment data is added to the distributed linked data structure through addition of a new block to contain the judgment data.

Example 34 includes the subject matter any one of examples 28-33, where the instructions are further executable to cause the processor to: identify a change to a set of rules used to determine the judgment; determine an updated judgment from the plurality of observations based on the change to the set of rules; and cause updated judgment data to be added to another block in the distributed linked data structure to describe the updated judgment.

Example 35 is a method including: identifying time boundaries of an event, where the event corresponds to an unsafe action by an autonomous machine within an environment; identifying geographic boundaries of the event associated with the environment; determining that a subset of blocks in a distributed linked data structure include a plurality of observations of the event based on the time boundaries and the geographic boundaries, where the subset of blocks include observation data describing the plurality of observations, and each of the plurality of observations is derived by a respective one of a plurality of devices from sensor data generated at the corresponding device; executing a consensus algorithm to determine a judgment from the plurality of observations; and causing judgment data to be added to a block of the distributed linked data structure to describe the judgment.

Example 36 includes the subject matter example 35, where the judgment data includes references to each one of the plurality of observations in the subset of blocks.

Example 37 includes the subject matter any one of examples 35-36, where at least one of the plurality of observations is generated by logic resident on the autonomous machine.

Example 38 includes the subject matter any one of examples 35-37, where the autonomous machine includes one of an autonomous vehicle or a robot.

Example 39 includes the subject matter any one of examples 35-38, further including: identifying addition of another observation of the event to a particular block of the distributed linked data structure after addition of the judgment block to the distributed linked data structure; determining a revised judgment for the event based on the other observation and the plurality of observations; and causing additional judgment data to be added to another block in the distributed linked data structure to describe the revised judgment.

Example 40 includes the subject matter any one of examples 35-39, where each of the plurality of observations is contained in a respective one of the subset of blocks, and the judgment data is added to the distributed linked data structure through addition of a new block to contain the judgment data.

Example 41 includes the subject matter any one of examples 35-40, further including: identifying a change to a set of rules used to determine the judgment; determining an updated judgment from the plurality of observations based on the change to the set of rules; and causing updated judgment data to be added to another block in the distributed linked data structure to describe the updated judgment.

Example 42 is a system including means to perform the method of any one of examples 35-41.

Example 43 is a system including: a data processor; a memory; a set of sensors; and a safety observation engine executable by the data processor to: identify a subset of sensor data generated by the set of sensors corresponding to a time and geography of a safety event, where the safety event corresponds to an autonomous movement by a machine; determine, from the subset of sensor data, an observation of the safety event, where the observation identifies the machine and describes attributes of the autonomous movement, where the attributes are associated with compliance with a safety standard; generate observation data to describe the observation; and cause the observation data to be stored in a block of a safety blockchain for use in determining a cause of the event based at least in part on the observation.

Example 44 includes the subject matter example 43, further including a machine learning engine to use one or more machine learning models to perform inferences based on the sensor data, where the observation is to be determined based at least in part on the inferences.

Example 45 includes the subject matter any one of examples 43-44, where the system includes one of a vehicle, a roadside sensor, a robot, or a drone.

Example 46 includes the subject matter any one of examples 43-45, where the system includes the machine.

Example 47 includes the subject matter any one of examples 43-46, further including a validator node to: validate the block; and add the block to the safety blockchain based on validation of the block.

Example 48 includes the subject matter any one of examples 43-47, where the observation is based on a standardized safety model, and the standardized safety model defines a set of calculations to model a set of safe operating standards, and the observation is generated, at least in part, using one or more of the set of calculations.

Example 49 includes the subject matter example 48, where the standardized safety model includes a Responsibility Sensitive Safety (RSS)-based model.

Example 50 includes the subject matter any one of examples 43-49, further including the machine, where the machine includes the safety observation engine.

Example 51 includes the subject matter example 50, where the machine includes an autonomous vehicle.

Example 52 includes the subject matter any one of examples 50-51, where the observation is determined, at least in part, using logic utilized by the machine to make decisions in association with performance of autonomous movement.

Example 53 includes the subject matter any one of examples 43-52, where the observation data includes time information corresponding to occurrence of the event and location information identifying geographic boundaries of the environment.

Example 54 includes the subject matter any one of examples 43-53, where the set of sensors include a plurality of different types of sensors.

Example 55 includes the subject matter any one of examples 43-54, where the observation identifies each one of a plurality of machines involved in the safety event.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. At least one machine-readable storage medium with instructions stored thereon, wherein the instructions are executable by a processor to cause the processor to:
access sensor data generated by sensors of a device in an environment;
determine, from the sensor data, an observation of an event, wherein the observation identifies movement of one or more machines within the environment in association with the event;
generate observation data to include in a distributed linked data structure, wherein the observation data identifies the observation; and
send the observation data to another system for storage in the distributed linked data structure.

2. The storage medium of claim 1, wherein generation of the observation data comprises performing an inference using a machine learning model based on at least a portion of the sensor data.

3. The storage medium of claim 1, wherein the observation is based on a standardized safety model, and the standardized safety model defines a set of calculations to model a set of safe operating standards, and the observation is generated, at least in part, using one or more of the set of calculations.

4. The storage medium of claim 3, wherein the standardized safety model comprises a Responsibility Sensitive Safety (RSS)-based model.

5. The storage medium of claim 1, wherein at least a particular one of the one or more machines is configured to move autonomously.

6. The storage medium of claim 5, wherein the particular machine comprises the device.

7. The storage medium of claim 6, wherein the particular machine comprises an autonomous vehicle.

8. The storage medium of claim 6, wherein the observation is determined, at least in part, using logic utilized by the machine to make decisions in association with performance of autonomous movement.

9. The storage medium of claim 1, wherein the distributed linked data structure comprises a blockchain data structure and the blockchain data structure comprises observation data to describe a plurality of observations for the event.

10. The storage medium of claim 9, wherein the instructions are further executable to cause the processor to generate a new block for inclusion in the blockchain data structure, the new block comprises the observation data, and each of the plurality of observations are contained in a respective one of a plurality of blocks to be included in the blockchain.

11. The storage medium of claim 1, wherein the observation data comprises time information corresponding to occurrence of the event and location information identifying geographic boundaries of the environment.

12. The storage medium of claim 1, wherein the sensor data is generated by a plurality of different types of sensors at the device.

13. The storage medium of claim 1, wherein the observation identifies each one of a plurality of machines involved in the event.

14. At least one machine-readable storage medium with instructions stored thereon, wherein the instructions are executable by a processor to cause the processor to:
identify time boundaries of an event, wherein the event corresponds to an unsafe action by an autonomous machine within an environment;
identify geographic boundaries of the event associated with the environment;
determine that a subset of blocks in a distributed linked data structure include a plurality of observations of the event based on the time boundaries and the geographic boundaries, wherein the subset of blocks comprise observation data describing the plurality of observations, and each of the plurality of observations is derived by a respective one of a plurality of devices from sensor data generated at the corresponding device;
execute a consensus algorithm to determine a judgment from the plurality of observations; and
cause judgment data to be added to a block of the distributed linked data structure to describe the judgment.

15. The storage medium of claim 14, wherein the judgment data includes references to each one of the plurality of observations in the subset of blocks.

16. The storage medium of claim 14, wherein at least one of the plurality of observations is generated by logic resident on the autonomous machine.

17. The storage medium of claim 14, wherein the autonomous machine comprises one of an autonomous vehicle or a robot.

18. The storage medium of claim 14, wherein the instructions are further executable to cause the processor to:
identify addition of another observation of the event to a particular block of the distributed linked data structure after addition of the judgment block to the distributed linked data structure;
determine a revised judgment for the event based on the other observation and the plurality of observations; and
cause additional judgment data to be added to another block in the distributed linked data structure to describe the revised judgment.

19. The storage medium of claim 14, wherein each of the plurality of observations is contained in a respective one of the subset of blocks, and the judgment data is added to the distributed linked data structure through addition of a new block to contain the judgment data.

20. A system comprising:
a data processor;
a memory;
a set of sensors; and
a safety observation engine executable by the data processor to:
identify a subset of sensor data generated by the set of sensors corresponding to a time and geography of a safety event, wherein the safety event corresponds to an autonomous movement by a machine;
determine, from the subset of sensor data, an observation of the safety event, wherein the observation identifies the machine and describes attributes of the autonomous movement, wherein the attributes are associated with compliance with a safety standard;
generate observation data to describe the observation; and
cause the observation data to be stored in a block of a safety blockchain for use in determining a cause of the event based at least in part on the observation.

21. The system of claim 20, further comprising a machine learning engine to use one or more machine learning models to perform inferences based on the sensor data, wherein the observation is to be determined based at least in part on the inferences.

22. The system of claim 20, wherein the system comprises one of a vehicle, a roadside sensor, a robot, or a drone.

23. The system of claim 20, wherein the system comprises the machine.

24. The system of claim 20, further comprising safety judge logic to:
determine that a subset of blocks in the distributed linked data structure include observation data for a plurality of observations of the event, wherein the plurality of observations comprises the observation, and each of the plurality of observations is derived by a respective one of a plurality of devices from sensor data generated at the corresponding device;
execute a consensus algorithm to determine a judgment from the plurality of observations; and
cause judgment data to be added to a particular block of the distributed linked data structure to describe the judgment.
